(19) United States
(12) Patent Application Publication
(10) Pub. No.: US 2014/0255223 A1
(43) Pub. Date: Sep. 11, 2014

(54) MECHANICAL ENGINE DRIVEN WATER PUMP

(71) Applicant: VaporGenics, Inc., Tampa, FL (US)

(72) Inventor: Dale F Solomon, Wadsworth, OH (US)

(73) Assignee: VaporGenics, Inc., Tampa, FL (US)

(21) Appl. No.: 14/198,096

(22) Filed: Mar. 5, 2014

Related U.S. Application Data
(60) Provisional application No. 61/773,754, filed on Mar. 6, 2013.

(51) Int. Cl. F03G 7/04; F04B 17/00

(52) U.S. Cl. CPC F03G 7/04; F04B 17/006
USPC 417/392

(57) ABSTRACT

A mechanical engine driven water pump is disclosed for converting energy from an input heat source to a reciprocating mechanical output for powering the water pump. The mechanical reciprocating engine comprises an engine bore having an input port and an output port. An engine piston is disposed in the engine bore. An engine valve assembly is slidably mounted to the engine piston for communicating the input port and the output port with opposed sides of the engine piston for effecting reciprocal motion of the engine piston. A piston shaft is connected to the reciprocal motion of the engine piston to provide the reciprocating mechanical output the water pump. A stuffing box is interposed between the mechanical reciprocating engine and the reciprocating mechanical output for providing a positive seal for the mechanical reciprocating engine. The heat source may comprise a solar heat source, a geothermal heat source, a byproduct heat source or the external burning of a petroleum product.

### CROSS REFERENCE TO RELATED APPLICATIONS

This application claims benefit of U.S. Patent Provisional application No. 61/773,754 filed Mar. 6, 2014. All subject matter set forth in provisional application No. 61/773,754 filed Mar. 6, 2014 is hereby incorporated by reference into the present application as if fully set forth herein.

### BACKGROUND OF THE INVENTION

1. Field of the Invention

This invention relates to water pumps and more particularly to a water pump driven by a mechanical reciprocating engine powered by external heat.

2. Description of the Related Art

The World Health Organization (WHO) and UNICEF report over 900 million people do not have access to a safe supply of drinking water. Unsafe drinking water results in various diarrhea diseases. It is estimated that the impact of diarrhea disease on children is greater than the combined impact of HIV/AIDS, tuberculosis and malaria. The majority of diarrhea diseases on children could be eliminated by providing a safe supply of drinking water.

The problem of safe drinking water is most acute in areas lacking electrical power such as rural areas and third world counties. In these rural areas and third world counties, hand water pumps and/or windmills were used to provide safe drinking water and water for irrigating crops. Hand water pumps required human or animal power to operate the hand water pump. In addition, many hand water pumps lacked reliability requiring servicing in remote areas.

Windmills have been used to provide safe drinking water and water for irrigation for some remote and rural areas. However, windmills are inappropriate for use in areas where wind is weak or inconsistent. Furthermore, windmills require the construction of a tower making windmills beyond the financial resources of many poverty stricken areas.

Many in the prior art have attempted to solve the problem of providing safe supply of drinking water in rural areas and third world counties. The following United States patents and/or published patent applications are example of the contributions of the prior art.

U.S. Pat. No. 4,621,679 to Byers, et al. discloses a valve for a water temperature control system having a heat exchanger, a tank, and a pump for circulating heat transfer fluid through a supply line from the tank to the heat exchanger and through a return line from the heat exchanger to the tank. A valve housing interposed in both the supply line and the return line has supply inlet and supply outlet connections, has return inlet and return outlet connections, and has first and second drain connections. A valve element associated with the valve housing has a first position for normally circulating the heat transfer fluid from the supply inlet connection to the supply outlet connection and from the return inlet connection to the return outlet connection and has a second position discontinuing circulation through the supply inlet connection and the return outlet connection and connecting the supply outlet connection to the first drain connection and the return outlet connection to the second drain connection. Actuation is provided for moving the valve element to the second position upon the occurrence of a reduction in the ambient temperature proximate the heat exchanger below a predetermined value, a loss of power to the valve, or a malfunction of the valve.

U.S. Pat. No. 4,666,373 to Sugiura discloses an impeller for a rotary fluid machine of the centrifugal type which is adapted to be constructed as a liquid pump or gas compressor. The impeller comprises a disc having a boss which is fitted on a drive shaft, and a plurality of blades which are uniformly spaced apart circumferentially and axially project from at least one side of the disc. Each blade has a front and a rear surface, and a fluid path is defined between the front surface of a blade and the rear surface of an adjacent blade. The fluid path is arranged to extend from around the boss to the outer periphery of the disc. The width of the fluid path decreases gradually from around the boss toward the outer periphery of the disc, but the fluid path has a constant depth. The front and the rear surface of each blade are substantially arranged along circular arcs having different radii of curvature which are struck from a common center point. Center points associated with different blades are disposed on a single imaginary circle which is concentric with the disc.

U.S. Pat. No. 4,917,079 to Solomon discloses a solar powered water heating system for heating water in a storage tank including a solar collector for converting a refrigerant from a liquid to a gaseous state. A pump communicates with the solar collector via a first refrigerant supply line and operable by the gaseous state of the refrigerant, a heat exchanger communicates with and receiving refrigerant from the pump, the heat exchanger transfers heat from the refrigerant to water passing therethrough from the storage tank, and lines supplying condensed refrigerant in the heat exchanger to the pump for return circulation to the solar collector. The system additionally has an atmospherically sealed regulating valve initially opening to pass fluid at a minimum selected pressure and remaining open to pass fluid until the fluid pressure reaches a selected reduced pressure. The system further includes a housing, a valve housing cap enclosing the open end of the housing, a valve element movable axially of the housing, a first chamber in the housing axially of the valve element in one direction, and a second chamber in the housing axially of the valve element in the other direction. A bore extends through the valve element connecting the first chamber and the second chamber. A fluid inlet passage supplies fluid to the first and second chambers, a third chamber in the housing communicates with fluid outlet passages, and a biasing element permitting movement of the valve element for fluid communication between the first chamber and the third chamber at the minimum selected pressure in the fluid inlet passage and effecting movement of the valve element for interrupting fluid communication between the first chamber and the third chamber at the selected reduced pressure.

U.S. Pat. No. 4,998,558 to Solomon discloses a solar powered water heating system including an atmospherically sealed regulating valve initially opening to pass fluid at a minimum selected pressure and remaining open to pass fluid until the fluid pressure reaches a selected reduced pressure. The disclosure includes a housing, a valve housing cap enclosing the open end of the housing, a valve element movable axially of the housing, a first chamber in the housing axially of the valve element in one direction, and a second chamber in the housing axially of the valve element in the other direction. A bore extends through the valve element connecting the first chamber and the second chamber. A fluid inlet passage supplies fluid to the first and second chambers. A third chamber in the housing communicates with fluid outlet passages, and a biasing element permits movement of the valve element for fluid communication between the first chamber and the third chamber at the minimum selected pressure in the fluid inlet passage and effecting movement of the valve element for interrupting fluid communication between the first chamber and the third chamber at the selected reduced pressure.

U.S. Pat. No. 5,129,236 to Solomon discloses a heat pump system including a power section having a generator for converting a first working fluid from a liquid to a relatively high pressure gas, a power unit providing energy by the conversion of the relatively high pressure gas to relatively low pressure gas to power a drive piston for intermittently delivering a power stroke. A power section condenser converts the first working fluid from relatively low pressure gas to the liquid. A compressor section is intermittently driven by the drive piston. The compressor section has a compressor converting relatively low pressure gas second working fluid to relatively high pressure gas second working fluid for circulating the second working fluid through a compressor section condenser. A compressor section evaporator effects heating and cooling operations. A combined power unit and compressor assembly may be employed which has a valve assembly for introducing the relatively high pressure gas to power the drive piston and for evacuating the relatively low pressure gas therefrom. A condensate pump circulates the liquid in the power section.

U.S. Pat. No. 5,275,014 to Solomon discloses a heat pump system including a power section having a generator for converting a first working fluid from a liquid to a relatively high pressure gas. A power unit provides energy by the conversion of the relatively high pressure gas to relatively low pressure gas to power a drive piston for intermittently delivering a power stroke. A power section condenser converts the first working fluid from relatively low pressure gas to the liquid. A compressor section is intermittently driven by the drive piston. The compressor section has a compressor converting relatively low pressure gas second working fluid to relatively high pressure gas second working fluid for circulating the second working fluid through a compressor section condenser. A compressor section evaporator effects heating and cooling operations. A combined power unit and compressor assembly may be employed which has a valve assembly for introducing the relatively high pressure gas to power the drive piston and for evacuating the relatively low pressure gas therefrom. A condensate pump circulates the liquid in the power section.

U.S. Pat. No. 5,275,365 to Solomon, et al. discloses a submersible pump cylinder for immersion in and displacement of a fluid, including a cylindrical housing, a plunger assembly positioned for reciprocating motion within the cylindrical housing, a sealing sleeve assembly attached to the cylindrical housing and to the plunger assembly and overlapped to maintain a convolution which moves during the reciprocating motion of said plunger assembly. A balance valve associated with the plunger assembly maintains pressure within the flexible sleeve, whereby the flexible sleeve is maintained in engagement with the housing and the plunger assembly and substantially without frictional interengagement during motion of the plunger assembly.

U.S. Pat. No. 5,365,908 to Takii, et al. discloses an internal combustion engine and method for operating the engine wherein a leaner than stoichiometric air/fuel ratio is maintained under all running conditions. The desired torque curve is obtained by increasing the amount of boost generated to the intake air charge without enriching the air/fuel mixture. In addition, an anti-knocking system is incorporated that avoids knocking by retarding the spark advance and, at the same time, providing a leaning in the air/fuel mixture.

U.S. Pat. No. 5,509,274 to Lackstrom discloses a high efficiency heat transfer system including a power circuit and heat pump circuit. Each circuit has a working fluid flowing therein. In the power circuit, a heater vaporizes the working fluid which is periodically delivered and exhausted through a valve assembly to a power unit. The power unit is also a compressor for the working fluid in the heat pump circuit. Fluid exhausted from the driven section of the power unit is passed to a four-way valve which selectively delivers the working fluid to an interior coil or an exterior coil to heat or cool an area. In extremely cold ambient temperatures, the area is heated directly from the power circuit using a by-pass exchanger.

U.S. Pat. No. 5,725,365 to Solomon, et al. discloses a submersible pump cylinder for immersion in and displacement of a fluid. The disclosure includes a cylindrical housing, a plunger assembly positioned for reciprocating motion within the cylindrical housing, a sealing sleeve assembly attached to the cylindrical housing and to the plunger assembly and overlapped to maintain a convolution which moves during the reciprocating motion of said plunger assembly. A balance valve associated with the plunger assembly maintains pressure within the flexible sleeve, whereby the flexible sleeve is maintained in engagement with the housing and the plunger assembly and substantially without frictional inter-engagement during motion of the plunger assembly.

U.S. Pat. No. 6,138,649 to Khair, et al. discloses a system for rapidly changing the flow of recirculated exhaust gas to each cylinder of an internal combustion engine operating on diesel fuel or other fuels. The system preferably includes an exhaust gas recirculation line having an exhaust gas recirculation pump along with a reservoir and cooler for storing a desired volume of recirculated exhaust gas. Recirculated exhaust gas is preferably supplied from the reservoir to each cylinder of the associated engine through respective recirculated exhaust gas conduits. A metering valve is preferably disposed within each recirculated exhaust gas conduit immediately adjacent to each cylinder. The metering valves provide uniform distribution of recirculated exhaust gas to the respective cylinders and allow the system to rapidly change the flow of recirculated exhaust gas to each cylinder. The system provides recirculated exhaust gas at a point close to the combustion chamber where it is needed for effective reduction of undesirable emissions.

U.S. Pat. No. 6,167,703 to Rumez, et al. discloses an exhaust gas turbocharger system for an internal combustion engine including a turbine portion with adjustable turbine geometry for powering a compressor portion which delivers a pressurized charge air mass flow to the internal combustion engine air intake. A charge regulator controls the turbine geometry so that the cross-section of exhaust gas flow to the turbine portion is decreased with an increased working load of the internal combustion engine. It is further proposed that at least one heat exchanger is exposed to the charge air circuit so that heated air is fed thereto for heating such as to heat engine lubricating oil.

U.S. Pat. No. 6,216,722 to Solomon discloses a freeze-resistant hydrant extending between a first area having a temperature at least intermittently below freezing and a second area having a temperature constantly above freezing. The disclosure includes a heat-transfer tube, wherein a first end of the heat-transfer tube proximate the first area, a second end of the heat-transfer tube extending into the second area, and a water line interposed within the heat-transfer tube from a location within the second area to the first end of the heat-transfer tube. A control valve is on the water line in proximity to the heat-transfer tube, and a heat-transfer fluid in the heat-transfer tube transfers heat from the second end of the heat-transfer tube to the control valve.

U.S. Pat. No. 6,467,269 to Dutart discloses a waste gate valve for a turbocharger system in an engine of a work machine, vehicle or the like particularly suitable for operation at changing altitudes. The waste gate valve includes a spring operating against an adjustable spring seat. The adjustable spring seat is adjusted in response to ambient pressure changes to alter the installed length of the spring.

U.S. Pat. No. 6,546,713 to Hidaka, et al. discloses a gas turbine for power generation operated at a turbine nozzle inlet temperature ranging from 1200 to 1650.degree. C., which is improved to obtain high heat efficiency by making disk blades and nozzles arranged in first to final stages from optimum materials and optimally cooling these disk blades and nozzles, and to obtain a combined power generation system using the gas turbine. The combined power generation system includes a highly efficient gas turbine operated at a turbine nozzle inlet combustion gas temperature ranging from 1200 to 1650 degrees C. and a high pressure-intermediate pressure-low pressure integral type steam turbine operated at a steam inlet temperature of 530.degree. C. or more, wherein the gas turbine is configured such that turbine blades, nozzles and disks are each cooled, and the blades and nozzles are each made from a Ni-based alloy having a single crystal or columnar crystal structure and disks are made from a martensite steel.

U.S. Pat. No. 6,554,088 to Severinsky et al. discloses a hybrid vehicle comprising an internal combustion engine, a traction motor, a starter motor, and a battery bank, all controlled by a microprocessor in accordance with the vehicle's instantaneous torque demands so that the engine is run only under conditions of high efficiency, typically only when the load is at least equal to 30% of the engine's maximum torque output. In some embodiments, a turbocharger may be provided, activated only when the load exceeds the engine's maximum torque output for an extended period; a two-speed transmission may further be provided, to further broaden the vehicle's load range. A hybrid brake system provides regenerative braking, with mechanical braking available in the event the battery bank is fully charged, in emergencies, or at rest; a control mechanism is provided to control the brake system to provide linear brake feel under varying circumstances.

U.S. Pat. No. 6,625,978 to Eriksson, et al. discloses a device and a method for exhaust gas purification in a combustion engine comprising an arrangement for recirculating exhaust gases from the engine to an air intake thereof. An exhaust gas purification arrangement is adapted to convert constituents in the exhaust gases to less environmentally hazardous substances. A filter arrangement comprises at least one filter adapted to liberate the exhaust gases from particulate constituents. This filter is adapted to purify EGR-exhaust gases only. According to another aspect of the invention, the filter is aged in heat transferring relation to at least one convener unit of the exhaust gas purification arrangement so as to receive, from the convener unit, a heat addition to promote regeneration of the filter by combustion of particulate constituents deposited therein.

U.S. Pat. No. 6,651,432 to Gray, Jr. discloses a method of operating an internal combustion engine wherein intake ambient air is boosted to a higher pressure by passage through at least one compressor and then introduced into the internal combustion engine. Fuel is also introduced into the internal combustion engine for providing combustion in admixture with the air charge at a combustion temperature approximating a target value. Various engine operating parameters, inclusive of torque demand, e.g., accelerator pedal depression, are sensed and the boosted pressure is changed in a manner proportional to a change in the sensed torque demand so as to maintain the combustion temperature at approximately the target value, i.e., below 2100 degrees K.

U.S. Pat. No. 6,732,723 to van Nieuwstadt discloses a method and system for controlling EGR rates of an internal combustion engine including measuring a mass airflow passing to the intake throttle and a desired mass airflow. An error signal is produced representative of a difference between the measured mass airflow and the desired mess airflow. A pair of control signals is produced in response to such produced error signal. One of the pair of control signals is used to adjust the intake throttle to control mass airflow through such intake throttle. The other one of the pair of control signals is used to adjust EGR flow through the EGR valve. The pair of control signals operates the intake throttle and the EGR valve to drive the error signal to a null. In one embodiment, one of the control signals used to adjust the EGR valve is used to provide such adjustment only when the intake throttle is in a position to provide substantially maximum mass airflow through such intake throttle to the intake of the engine. In another embodiment, the pair of control signals operates to drive the throttle to a closed position only when such error signal is unable to be driven towards the null solely from adjustment by the EGR valve.

U.S. Pat. No. 6,739,139 to Solomon discloses a heat pump system including a heat generator. A heat engine is supplied with heat engine working fluid by the heat generator. The heat engine has a heat engine cylinder chamber, a heat engine piston, and a heat engine piston rod. A preheating chamber employs the heat engine working fluid to heat the heat engine cylinder chamber, a compressor is driven by the heat engine employing compressor working fluid and having a compressor cylinder chamber, a compressor piston, and a compressor piston rod, a spacer separating and joining the heat engine piston rod and the compressor piston rod. A sealing assembly associated with the spacer separates the heat engine working fluid and the compressor working fluid. A valve assembly communicates with the heat engine cylinder chamber and controls the ingress and egress of heat engine working fluid to the heat engine.

U.S. Pat. No. 6,896,789 to Ross discloses a system for producing one or more gases for enhancing combustion in an internal combustion engine having an intake. The system comprises: an electrolysis cell, for generating one or more combustion enhancing gases under pressure; a gas conduit, for connecting the electrolysis cell to the internal combustion engine; and a flow regulator, operatively connected between the electrolysis cell and the intake of the engine, for regulating a flow of the combustion enhancing gases to the engine.

U.S. Pat. No. 7,003,964 to Solomon discloses a heat pump system including a heat generator and a heat engine supplied with heat engine working fluid by the heat generator. The heat engine has a heat engine cylinder chamber, a heat engine piston, and a heat engine piston rod, and a preheating chamber employing the heat engine working fluid to heat the heat engine cylinder chamber. A compressor driven by the heat engine employing compressor working fluid has a compressor cylinder chamber, a compressor piston, and a compressor piston rod. A spacer separates and joins the heat engine piston rod and the compressor piston rod. A sealing assembly associated with the spacer separates the heat engine working fluid and the compressor working fluid. A valve assembly communicates with the heat engine cylinder chamber and controls the ingress and egress of heat engine working fluid to the heat engine.

U.S. Pat. No. 7,207,188 to Solomon discloses a heat pump system including a heat generator and a heat engine supplied with heat engine working fluid by the heat generator. The heat engine has a heat engine cylinder chamber, a heat engine piston, and a heat engine piston rod, and a preheating chamber employing the heat engine working fluid to heat the heat engine cylinder chamber. A compressor driven by the heat engine employing compressor working fluid has a compressor cylinder chamber, a compressor piston, and a compressor piston rod. A spacer separates and joins the heat engine piston rod and the compressor piston rod. A sealing assembly associated with the spacer separates the heat engine working fluid and the compressor working fluid. A valve assembly communicates with the heat engine cylinder chamber and controls the ingress and egress of heat engine working fluid to the heat engine.

U.S. Patent Application 2004/0237562 to Solomon discloses a heat pump system including a heat generator, a heat engine supplied with heat engine working fluid by the heat generator having a heat engine cylinder chamber, a heat engine piston, and a heat engine piston rod. A preheating chamber employs the heat engine working fluid to heat the heat engine cylinder chamber. A compressor driven by the heat engine employs compressor working fluid having a compressor cylinder chamber, a compressor piston, and a compressor piston rod. A spacer separates and joins the heat engine piston rod and the compressor piston rod. A sealing assembly associated with the spacer separates the heat engine working fluid and the compressor working fluid. A valve assembly communicates with the heat engine cylinder chamber and controls the ingress and egress of heat engine working fluid to the heat engine.

U.S. Patent Application 2006/0117783 to Solomon discloses a heat pump system including a heat generator, a heat engine supplied with heat engine working fluid by the heat generator having a heat engine cylinder chamber, a heat engine piston, and a heat engine piston rod. A preheating chamber employs the heat engine working fluid to heat the heat engine cylinder chamber. A compressor driven by the heat engine employs compressor working fluid having a compressor cylinder chamber, a compressor piston, and a compressor piston rod. A spacer separates and joins the heat engine piston rod and the compressor piston rod. A sealing assembly associated with the spacer separates the heat engine working fluid and the compressor working fluid. A valve assembly communicates with the heat engine cylinder chamber and controls the ingress and egress of heat engine working fluid to the heat engine.

Although the above United States patents and/or published patent applications have contributed to the art, none of these United States patents and/or published patent applications have solved the problem of providing a supply of safe drinking water and/or water for irrigation in an economical manner.

Therefore, it is an object of the present invention to provide a mechanical engine driven water pump powered by an external heat source.

Another object of the present invention is to provide a mechanical engine driven water pump that is powered by an external heat source such as solar heat source, a geothermal heat source, a byproduct heat source or an external burning of a petroleum product.

Another object of the present invention is to provide a mechanical engine driven water pump for providing a supply of safe drinking water and/or water for irrigation in an economical manner.

Another object of the present invention is to provide a mechanical engine driven water pump that incorporates a novel stuffing box for sealing the mechanical engine.

Another object of the present invention is to provide a mechanical reciprocating engine that is economical to install and is economical to operate for extended periods of time.

The foregoing has outlined some of the more pertinent objects of the present invention. These objects should be construed as being merely illustrative of some of the more prominent features and applications of the invention. Many other beneficial results can be obtained by modifying the invention within the scope of the invention. Accordingly other objects in a full understanding of the invention may be had by referring to the summary of the invention, the detailed description describing the preferred embodiment in addition to the scope of the invention defined by the claims taken in conjunction with the accompanying drawings.

### SUMMARY OF THE INVENTION

The present invention is defined by the appended claims with specific embodiments being shown in the attached drawings. For the purpose of summarizing the invention, the invention relates to an improved A mechanical engine driven water pump for converting energy from an input heat source to a reciprocating mechanical output for powering the water pump. The mechanical reciprocating engine comprises an engine housing extending between a first and a second end. An engine bore is defined in the engine housing. An input port and an output port extend through the engine housing to communicate with said engine bore. An engine piston is disposed in the engine bore. An engine valve assembly is slidably mounted to the engine piston for communicating the input port and the output port with opposed sides of the engine piston for effecting reciprocal motion of the engine piston. A piston shaft connects the reciprocal motion of the engine piston to the reciprocating mechanical output. A stuffing box is interposed between the mechanical reciprocating engine and the reciprocating mechanical output for providing a positive seal for the mechanical reciprocating engine.

The heat source comprises a differential in a fluid temperature. The heat source may comprise a solar heat source, a geothermal heat source, a byproduct heat source or an external burning of a petroleum product. Preferably, the reciprocating mechanical output comprises a water pump.

In one embodiment of the invention, the engine valve assembly comprises a shuttle valve slidably mounted within the engine piston. The shuttle valve has an internal tube bore communicating with opposed first and second sides of the engine piston. A spring loaded toggle urges the shuttle valve into a first and a second toggle position. A mechanical actuator actuates sequentially the spring loaded toggle into one of the first and a second position to communicate the input port with sequentially the opposing first and second sides of the engine piston for effecting reciprocal motion of the engine piston.

In a more specific embodiment of the invention, the stuffing box includes plural diaphragms for providing the positive seal for the mechanical reciprocating engine.

The foregoing has outlined rather broadly the more pertinent and important features of the present invention in order that the detailed description that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be made to the following detailed description taken in connection with the accompanying drawings in which:

FIG. 1 is a diagram illustrating the mechanical engine driven water pump of the present invention connected to a heat source shown as a solar panel for powering a submersible water pump;

FIG. 2 is an enlarged view of the mechanical engine driven water pump of FIG. 1;

FIG. 3 is a top view of FIG. 2;

FIG. 4 is a sectional view along line 3-3 in FIG. 3 in a first operating position;

FIG. 5 is an enlarged view of FIG. 4;

FIG. 6 is a magnified view of a portion of FIG. 5;

FIG. 7 is a sectional view along line 7-7 in FIG. 6;

FIG. 8 is a magnified view of a stuffing box of FIG. 5;

FIG. 9 illustrates the mechanical engine driven water pump of FIG. 4 in a second operating position;

FIG. 10 is an enlarged view of FIG. 9;

FIG. 11 is a magnified view of a portion of FIG. 10;

FIG. 12 is a sectional view along line 12-12 in FIG. 11;

FIG. 13 is a magnified view of a stuffing box of FIG. 10;

FIG. 14 illustrates the mechanical engine driven water pump of FIG. 4 in a third operating position;

FIG. 15 is an enlarged view of FIG. 14;

FIG. 16 is a magnified view of a portion of FIG. 15;

FIG. 17 is a sectional view along line 17-17 in FIG. 16;

FIG. 18 is a magnified view of a stuffing box of FIG. 15;

FIG. 19 illustrates the mechanical engine driven water pump of FIG. 4 in a forth operating position;

FIG. 20 is an enlarged view of FIG. 18;

FIG. 21 is a magnified view of a portion of FIG. 20;

FIG. 22 is a sectional view along line 22-22 in FIG. 21;

FIG. 23 is a magnified view of a stuffing box of FIG. 20;

FIG. 24 illustrates the mechanical engine driven water pump of FIG. 4 in a fifth operating position;

FIG. 25 is an enlarged view of FIG. 24;

FIG. 26 is a magnified view of a portion of FIG. 25;

FIG. 27 is a sectional view along line 27-27 in FIG. 26;

FIG. 28 is a magnified view of a stuffing box of FIG. 25;

FIG. 29 illustrates the mechanical engine driven water pump of FIG. 4 in a sixth operating position;

FIG. 30 is an enlarged view of FIG. 29;

FIG. 31 is a magnified view of a portion of FIG. 30;

FIG. 32 is a sectional view along line 32-32 in FIG. 31;

FIG. 33 is a magnified view of a stuffing box of FIG. 30;

FIG. 34 illustrates the mechanical engine driven water pump of FIG. 4 in a seventh operating position;

FIG. 35 is an enlarged view of FIG. 34;

FIG. 36 is a magnified view of a portion of FIG. 35.

FIG. 37 is a sectional view along line 37-37 in FIG. 36; and

FIG. 38 is a magnified view of a stuffing box of FIG. 35.

Similar reference characters refer to similar parts throughout the several Figures of the drawings.

### DETAILED DISCUSSION

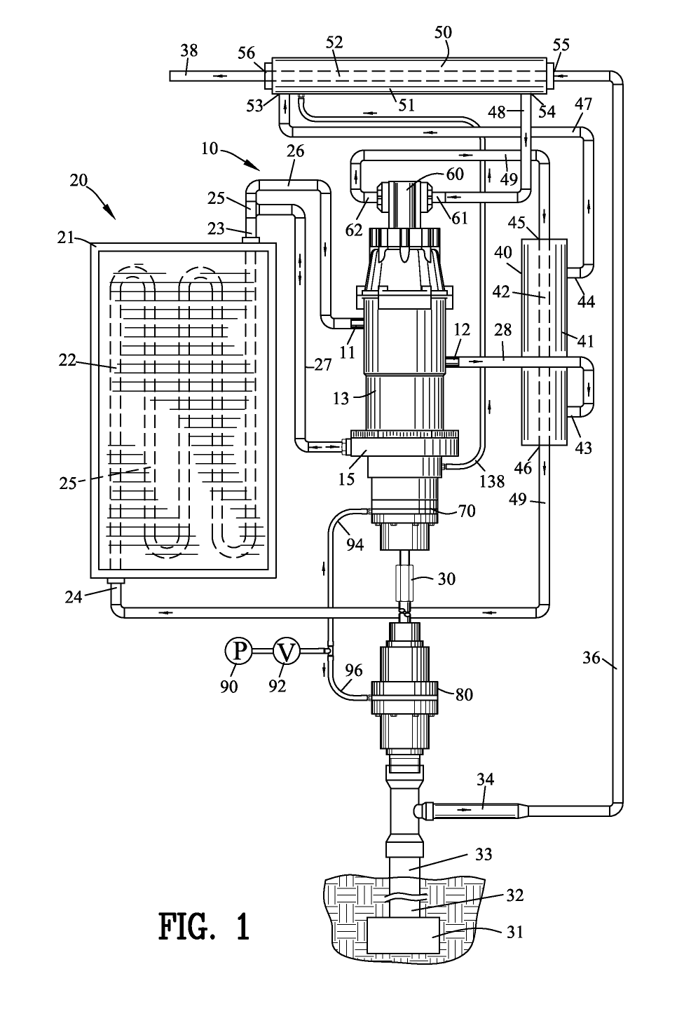

FIG. 1 is a diagram illustrating mechanical engine driven water pump 5 comprising a mechanical reciprocating engine 10 connected to a heat source 20. The heat source 20 may comprise a solar heat source, a geothermal heat source, a byproduct heat source or an external burning of a petroleum product. In this embodiment, the heat source 20 is shown as a solar panel 21. It should be understood the heat source 20 may comprises virtually any type of heat source providing a suitable differential in temperature.

The mechanical reciprocating engine 10 receives the energy from the heat source 20 to produce a reciprocating mechanical output 30 from the mechanical reciprocating engine 10. The mechanical output 30 is connected to a submersible water pump 31 located in a well casing 32. Preferably, the submersible water pump 31 is the submersible water pump set forth in U.S. Pat. No. 5,725,365 which is incorporated by reference into the present specification as if fully set forth herein. The reciprocating mechanical output 30 of the mechanical reciprocating engine 10 powers the submersible water pump 31 to pump water from a well casing 32 to a well head 33. A well output 34 is connected to the well head 33 for discharging the pumped water for clean water use. The pump water from the well output 34 is directed by a conduit 36 to cool the mechanical reciprocating engine 10 as will be described in greater detail hereinafter prior to being discharged from a terminal output 36.

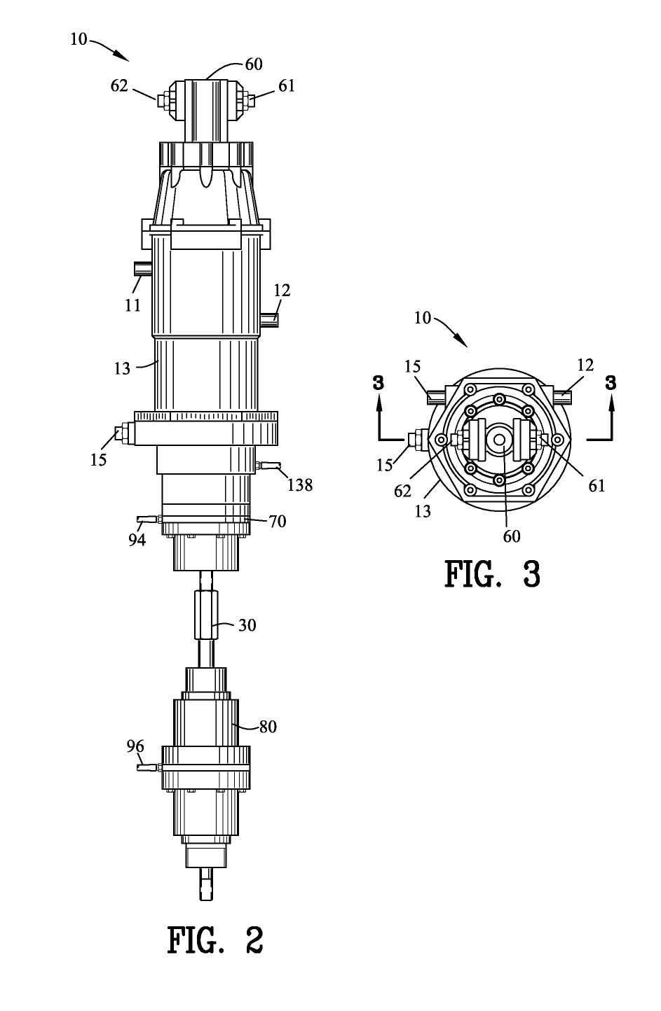

FIGS. 2 and 3 are an enlarged view of the mechanical reciprocating engine 10 of FIG. 1. The mechanical reciprocating engine 10 includes an input port 11 and an output port 12 defined in an engine housing 13. A pre-heater 15 is secured to be in thermal contact with the engine housing 13.

The solar panel 21 is connected to the input and output ports 11 and 12 of the engine housing 13 through a heat exchanger 40, a condenser 50 and a condensate pump 60. The solar panel 21 includes an internal channel 22 extending between first and a second channel end 23 and 24. The internal channel 22 of the solar panel 21 receives solar energy to heat a refrigerant fluid 25 within the internal channel 22 of the solar panel 21. The heated refrigerant fluid 25 from the first end 23 of the internal channel 22 is connected to the input port 11 of the engine housing 13 of the mechanical reciprocating engine 10 by an input conduit 26. A secondary input conduit 27 connects the first end 23 of the internal channel 22 to a preheater 15. The operation of the mechanical reciprocating engine 10 as will be described in greater detail hereinafter.

The heat exchanger 40 functions to increase the efficiency of the mechanical reciprocating engine 10. The heat exchanger 40 includes a first heat exchanger region 41 and a second heat exchanger region 42. In this example, the heat exchanger 40 is shown as a coaxial heat exchanger with the first heat exchanger region 41 surrounding the second heat exchanger region 42. The first heat exchanger region 41 includes an input 43 and an output 44. Similarly, the second heat exchanger region 42 includes an input 45 and an output 46.

The output port 12 of the engine housing 13 of the mechanical reciprocating engine 10 is connected to the input 43 of the first heat exchanger region 41 of the heat exchanger 40 by an output conduit 28. The output 44 of the first heat exchanger region 41 is connected to the condenser 50.

The condenser 50 includes a first condenser region 51 and a second condenser region 52. In this example, the condenser 50 is shown as a coaxial condenser with the first condenser region 51 surrounding the second condenser region 52. The first condenser region 51 includes an input 53 and an output 54. Similarly, the second condenser region 52 includes an input 55 and an output 56. The output 44 of the first heat exchanger region 41 is connected to the input 53 of the first condenser region 51 of the condenser 50 by a conduit 47.

The condensate pump 60 includes an input 61 and an output 62. The condensate pump 60 is secured to the engine housing 13 and is operated by the mechanical reciprocating engine 10. A conduit 48 connects the output 54 of the first condenser region 51 to the condensate pump 60. A conduit 49 connects an output 62 of the condensate pump 60 to the input 45 of the second heat exchanger region 42 of the heat exchanger 40. A continuation of conduit 49 connects the output 46 of the second heat exchanger region 42 to the second channel end 24 of the solar panel 21.

An internal stuffing box 70 is connected to the engine housing 13. The internal stuffing box 70 inhibits the leakage of any refrigerant fluid 25 from the engine housing 13 as will be described in greater detail hereinafter.

An external internal stuffing box 80 is connected to the well head to inhibit the leakage of any water from the well head 33. The reciprocating mechanical output 30 is connected to the submersible water pump 31 by an external stuffing box 80.

A mechanical air pump 90 is connected through a valve 92 and diaphragm air pressure conduits 94 and 96 to internal stuffing box 70 and the external stuffing box 80. The mechanical air pump 90 pressurizes diaphragms in the internal stuffing box 70 and the external stuffing box 80. The mechanical air pump 90 may be a simple air pump such as a mechanical tire pump, a mechanical bicycle pump or the like.

The mechanical reciprocating engine 10 operates in the following manner from the vapor cycle produced by the input heat source 20, a heat exchanger 40, the condenser 50 and the condensate pump 60. The refrigerant fluid 25 is selected to have a boiling point within the operating temperature of the solar panel of 21. The liquid phase of the refrigerant fluid 25 is heated within the internal channel 22 of the solar panel 21 to boil into a hot vapor phase of the refrigerant fluid 25. The hot vapor phase of the refrigerant fluid 25 enters the input port 11 of the mechanical reciprocating engine 10. The hot vapor phase of the refrigerant fluid 25 powers the mechanical reciprocating engine 10 as will be described in greater detail hereinafter.

Exhaust vapor phase of the refrigerant fluid 25 exits the output port 12 to pass through the first region 41 of the heat exchanger 40 and enter into the first region 51 of the condenser 50. The warm vapor phase of the refrigerant fluid 25 is cooled in the heat exchanger into a liquid phase of the refrigerant fluid 25 by well water entering into the second region 52 of the condenser 50. Cool well water from the well output 34 is directed by conduit 38 into the input 55 of the second region 52 of the condenser 50. The well water exits the second region 52 of the condenser 50 from the output 56 in communication with the terminal well output 38.

The liquid phase of the refrigerant fluid 25 is drawn from the first region 51 of the condenser 50 by the condensate pump 60. The condensate pump 60 pumps the liquid phase of the refrigerant fluid 25 through the second region 42 of the heat exchanger 40. The heat exchanger 40 preheats liquid phase of the refrigerant fluid 25 prior to entering the second channel and 24 of the internal channel 22 of the solar panel 21. This completes the vapor cycle operation of the system powering the mechanical reciprocating engine 10.

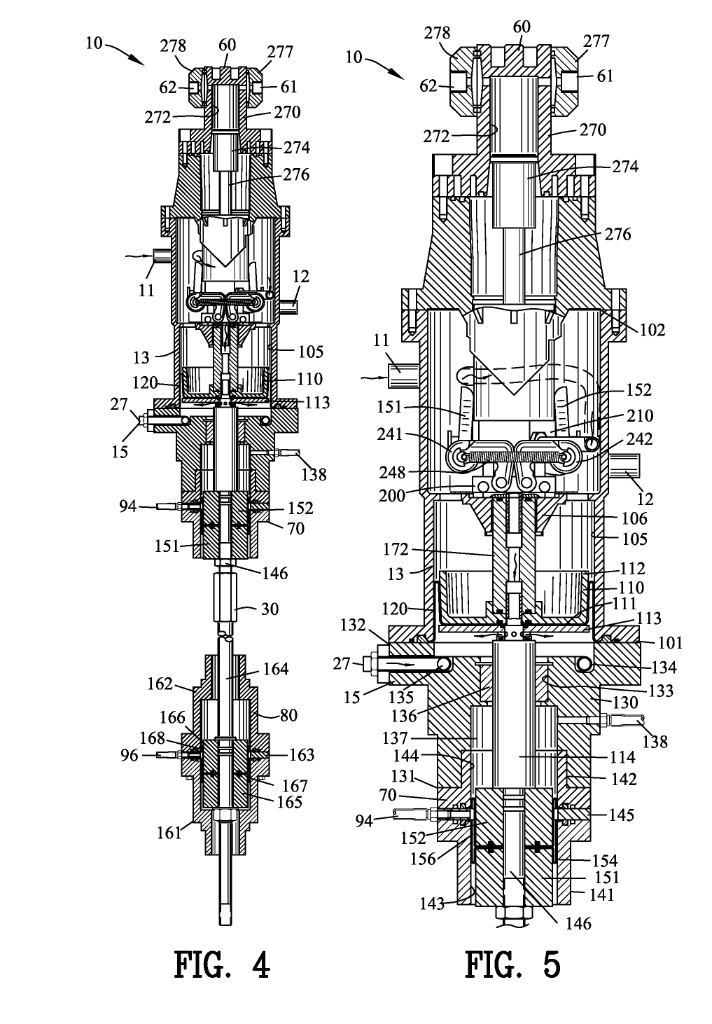

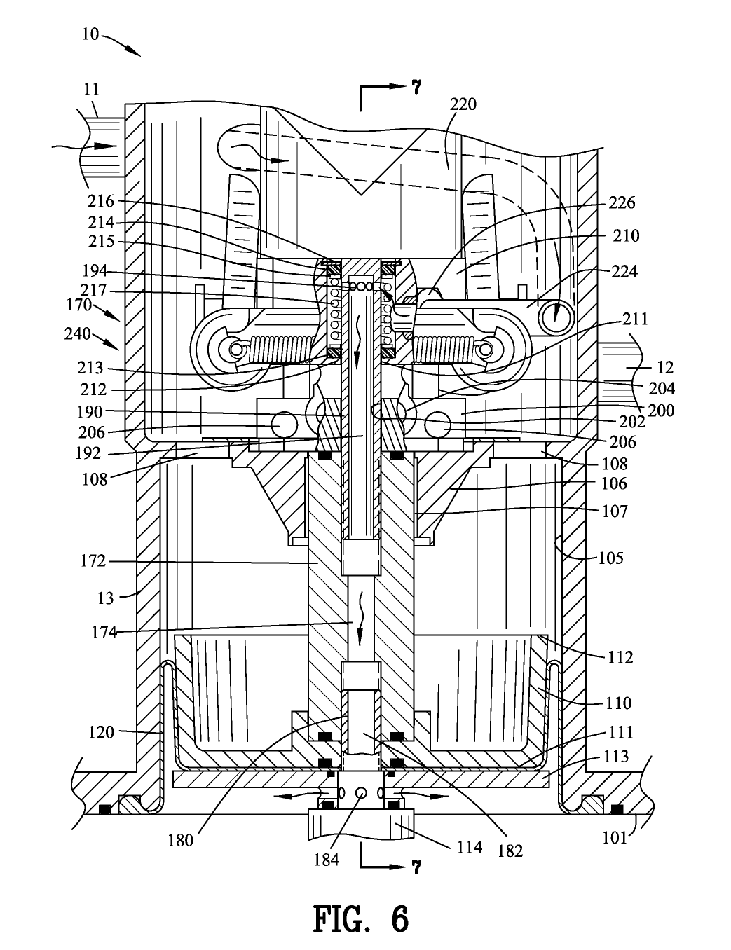

FIGS. 4-6 are sectional views illustrating the mechanical reciprocating engine 10 in a first operating position. The engine housing 13 extends between a first and a second end 101 and 102. An engine bore 105 is defined in the engine housing 13. The input port 11 and the output port 12 extending through the engine housing 13 to communicate with the engine bore 105. A housing support 106 extends inwardly from the engine housing 13. The housing support 106 defines a central guide aperture 107 and housing support apertures 108.

A piston 110 having a first and a second side 111 and 112 is disposed in the engine bore 105. A piston plate 113 is located adjacent to the first side 111 of the piston 110. A piston shaft 114 is secured to the piston 110 and the piston plate 113.

A flexible piston diaphragm 120 is interposed between the first side 111 of the piston 110 and the piston plate 113. The outer periphery of the flexible diaphragm 120 is secured between the first end 102 of the engine housing 13 and a pre-heater housing 130.

The pre-heater housing 130 defines a first end 131 and a second end 132. A central bore 133 is defined in the pre-heater housing 130. An annular void 134 is defined about the central bore 133 for receiving a pre-heater coil 135. The pre-heater coil 135 is connected to the secondary input conduit 27 from the solar panel 21.

A seal 136 is defined in the central bore 133 for slidably receiving the piston shaft 114. The seal 136 inhibits the refrigerant fluid 25 from escaping from the engine bore 105. Any refrigerant fluid 25 that leaks through the seal 136 accumulates in a pre-heater void 137. A diaphragm vent conduit 138 directs any accumulated refrigerant fluid 25 to the first side 51 of the condenser 50.

The inner stuffing box 70 is connected to the preheater housing 130 for sealing the piston shaft 14. The inner stuffing box 70 comprises an inner stuffing box lower housing 141 and an inner stuffing box upper housing 142. The inner stuffing box lower housing 141 defines an inner stuffing box upper housing bore 143 whereas the inner stuffing box upper housing 142 defines an inner stuffing box lower housing bore 144. An inner stuffing box sealing plate 145 is interposed between the inner stuffing box lower and upper housings 141 and 142. A stuffing box shaft 146 is secured to the piston shaft 114 attached to the piston 110.

An inner stuffing box lower piston and upper piston 151 and 152 are secured to the stuffing box shaft 146. An inner stuffing box lower diaphragm 154 is interposed between the inner stuffing box lower piston and upper piston 151 and 152. A periphery of the stuffing box lower diaphragm 154 is secured between the inner stuffing box lower housing 141 and the inner stuffing box sealing plate 145.

An inner stuffing box upper diaphragm 156 is interposed between the inner stuffing box lower piston and upper piston 151 and 152. A periphery of the stuffing box upper diaphragm 156 is secured between the inner stuffing box upper housing 142 and the inner stuffing box sealing plate 145.

The diaphragm air pressure conduit 94 communicates with the inner stuffing box lower housing bore 143 and the upper housing bore 144 between the inner stuffing box lower diaphragm 154 and the inner stuffing box upper diaphragm 156. The introduction of air pressure by air pump 90 provides an air cushion between the inner stuffing box lower diaphragm 154 and the inner stuffing box upper diaphragm 156. The inner stuffing box lower diaphragm 154 and the inner stuffing box upper diaphragm 156 prevent leakage of any refrigerant fluid 25 from the engine housing 13. In addition, the introduction of air pressure between the inner stuffing box lower diaphragm 154 and the inner stuffing box upper diaphragm 156 prevents interaction between the inner stuffing box lower and upper diaphragms 154 and 156. The inner stuffing box 70 provides plural diaphragms 154 and 156 for providing the positive seal for said mechanical reciprocating engine 10.

The outer stuffing box 80 comprises an outer stuffing box lower housing 161 and an outer stuffing box upper housing 162. An outer stuffing box sealing plate 163 is interposed between the outer stuffing box lower and upper housings 161 and 162. A stuffing box shaft 164 is secured to the stuffing box shaft 146 through the reciprocating mechanical output 30 shown as a coupling.

An outer stuffing box lower piston and upper piston 165 and 166 are secured to the stuffing box shaft 164. An outer stuffing box lower diaphragm 167 is interposed between the outer stuffing box lower piston and upper piston 165 and 166 and is secured between the outer stuffing box lower housing 161 and the outer stuffing box sealing plate 163. An outer stuffing box upper diaphragm 168 is interposed between the outer stuffing box lower piston and upper piston 165 and 166 and is secured between the outer stuffing box upper housing 162 and the outer stuffing box sealing plate 163.

The diaphragm air pressure conduit 96 communicates with the outer stuffing box housing 80 between the outer stuffing box lower diaphragm 167 and the outer stuffing box upper diaphragm 168. The introduction of air pressure by air pump 90 provides an air cushion between the outer stuffing box lower diaphragm 167 and the outer stuffing box upper diaphragm 168 The outer stuffing box lower diaphragm 167 and the outer stuffing box upper diaphragm 168 prevent leakage of any water from the well head 33.

The mechanical reciprocating engine 10 includes an engine valve assembly 170 for controlling the flow of the refrigerant fluid 25 into the input 11 and from the output 12 of the engine housing 13. The engine valve assembly 170 comprises a valve connecting shaft 172 defining a valve connecting shaft bore 174. The valve connecting shaft 172 is secured to the piston 110 by suitable means such as a threaded engagement or a press fit engagement. The valve connecting shaft 172 is slidably supported by central guide aperture 107 of the housing support 106 extending inwardly from the engine housing 13.

A first valve port 180 comprises a first valve tube 182 defining first port apertures 184. The first valve port 180 is secured within the valve connecting shaft bore 174. The first port apertures 184 communicate with the valve connecting shaft bore 174 of the valve connecting shaft 172.

A second valve port 190 comprises a second valve tube 192 defining second port apertures 194. The second valve port 190 is secured within the valve connecting shaft bore 174. The second port apertures 194 communicate with the valve connecting shaft bore 174 of the valve connecting shaft 172.

A shuttle plate 200 defines a shuttle plate aperture 202 for securing to the valve connecting shaft 172. The shuttle plate 200 moves in unison with the piston 110. The shuttle plate 200 includes plural shuttle plate pivots 204 and plural shuttle plate stops 206.

A shuttle body 210 defines a shuttle body aperture 211 for slidably receiving the valve connecting shaft 172. The shuttle body aperture 211 defines a lower shoulder 212 for locating a lower seal 213. An upper seal 214 is secured in place by a retaining washer 215 and a retaining snap ring 216. A spring 217 urges the lower seal 213 and the upper seal 214 into engagement with the lower shoulder 212 and the retaining washer 215, respectively.

A shuttle body port 220 is defined within the shuttle body 210. The shuttle body port 220 is coupled for communicating the input port 11 to the valve connecting shaft bore 174 of the valve connecting shaft 172. The flexible hose 224 interconnects the input port 11 to a fitting 226. The fitting 226 connected to the shuttle body aperture 202 to communicate with the valve connecting shaft 174.

Shuttle body posts 231 and 232 extend from opposed sides of the shuttle body 210. The shuttle body posts 231 and 232 assists in aligning a spring loaded toggle 240 the shuttle body 210.

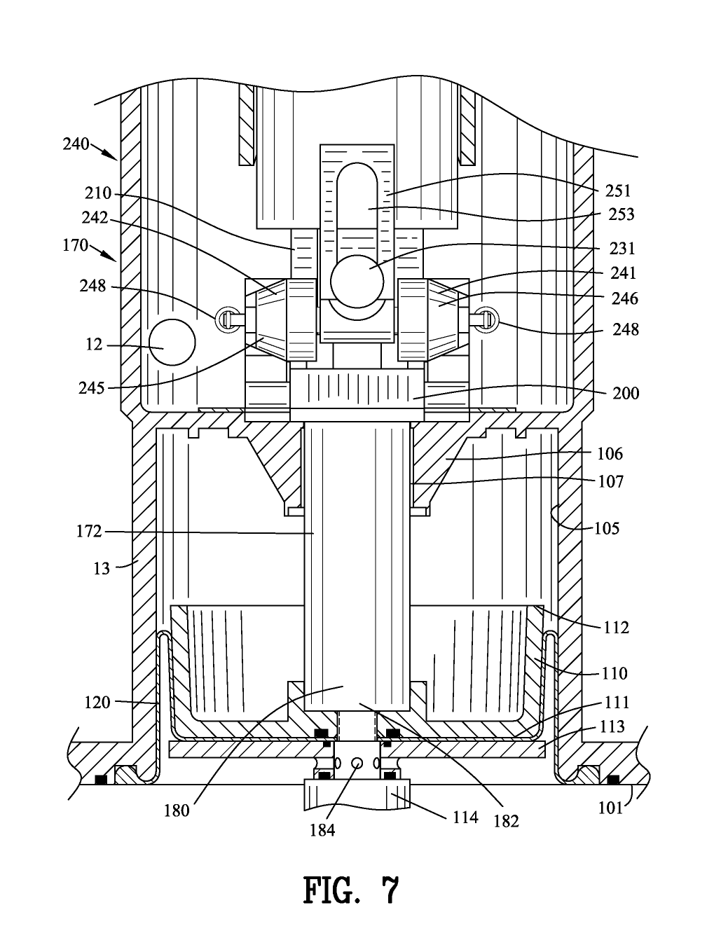

The spring loaded toggle 240 comprises toggle arms 241 and 242 having pivot apertures 243 and 244, respectively. Each of the toggle arms 241 and 242 include plural toggle arms as best shown in FIG. 7. The pivot apertures 243 and 244 are pivotably mounted to the shuttle plate pivots 204 of the shuttle plate 200. The toggle arms 241 and 242 include cylindrical ends 245 and 246 are interconnected by a spring 248.

The plural toggle arms 241 support a guide 251 having a slot 253 whereas the plural toggle arms 242 support a guide 252 having a slot 254. The slots 253 and 254 received the shuttle body posts 231 and 232 to guide the movement of the spring loaded toggle 240 relative to the shuttle body 210.

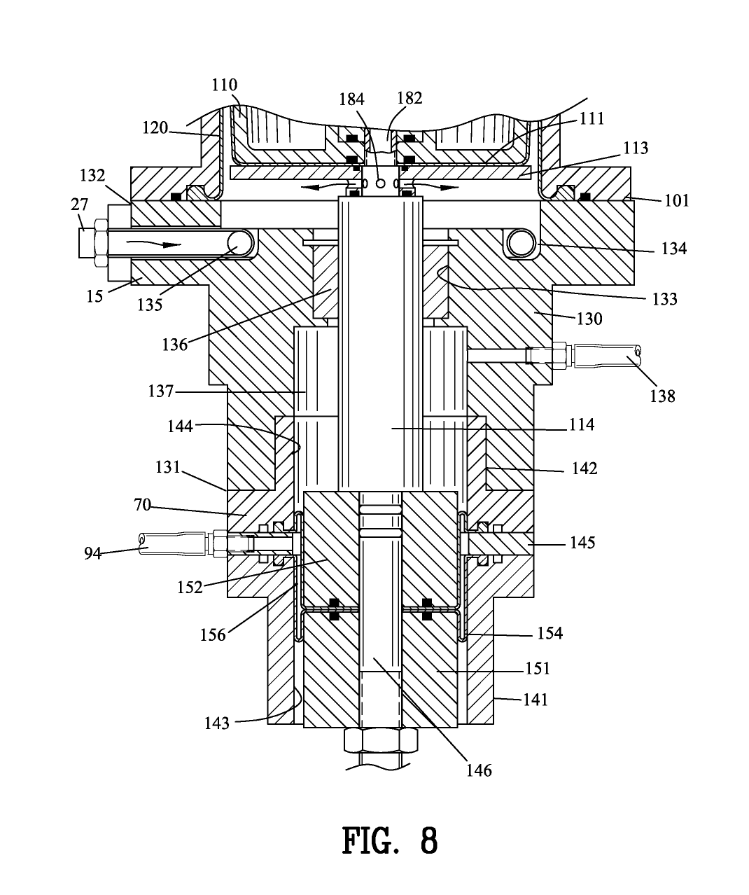

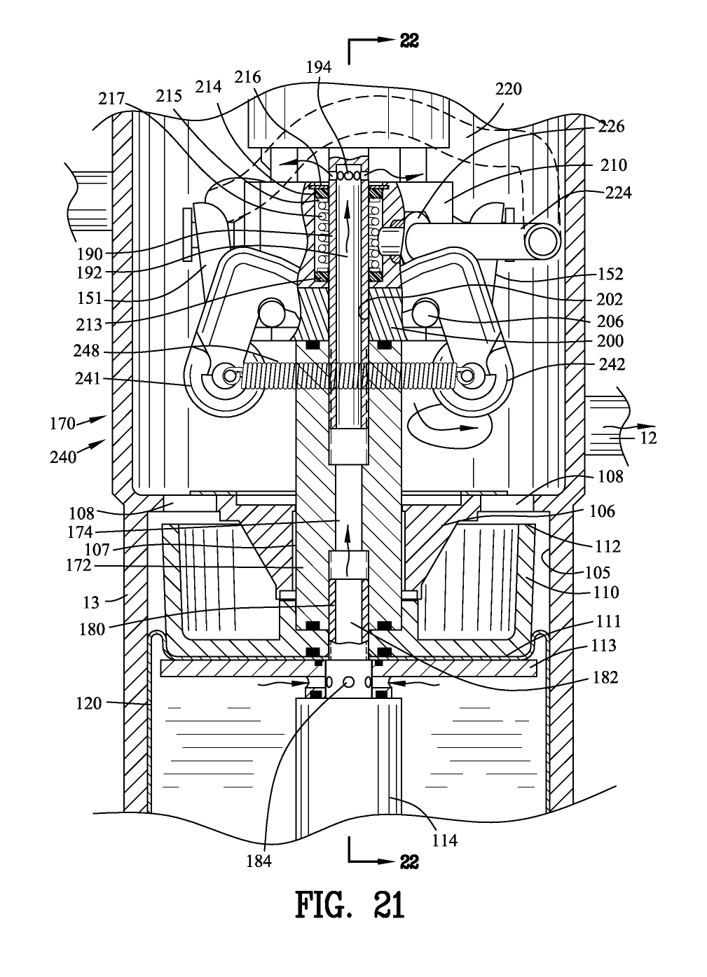

A V-shaped stop 260 is secured relative to the engine housing 13. As will be described in greater detail hereinafter, the V-shaped stop 260 cooperates with the plural toggle arms 241 and 242 to trigger the spring loaded toggle 240 from a first location as shown in FIG. 8 to a second location as shown in FIG. 21.

The condensate pump 60 comprises the condensate housing 270 defining a bore 272 for receiving a condensate piston 274. A condensate piston shaft 276 is connected for a moment with the heat engine piston 110. One-way valves 277 and 278 are disposed in the condensate pump input and output 61 and 62. Reciprocation of the heat engine piston 110 results in reciprocation of the condensate piston 274 tbr pumping the refrigerant fluid from the condensate pump input 61 to the condensate pump output 62.

The mechanical engine driven water pump 5 operates in the flowing manner. Initially, hot vapor phase of the refrigerant fluid 25 from the solar panel 21 passes through the secondary input conduit 27 to enter into the preheater 15. The hot vapor phase of the refrigerant fluid 25 initially heats the mechanical reciprocating engine 10.

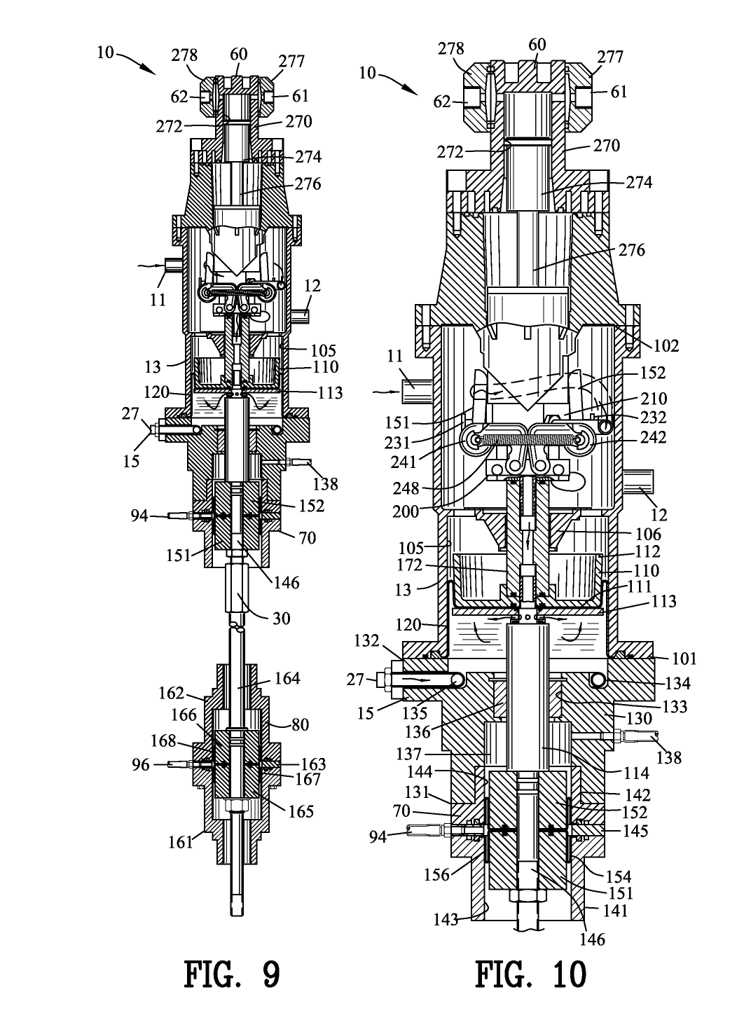

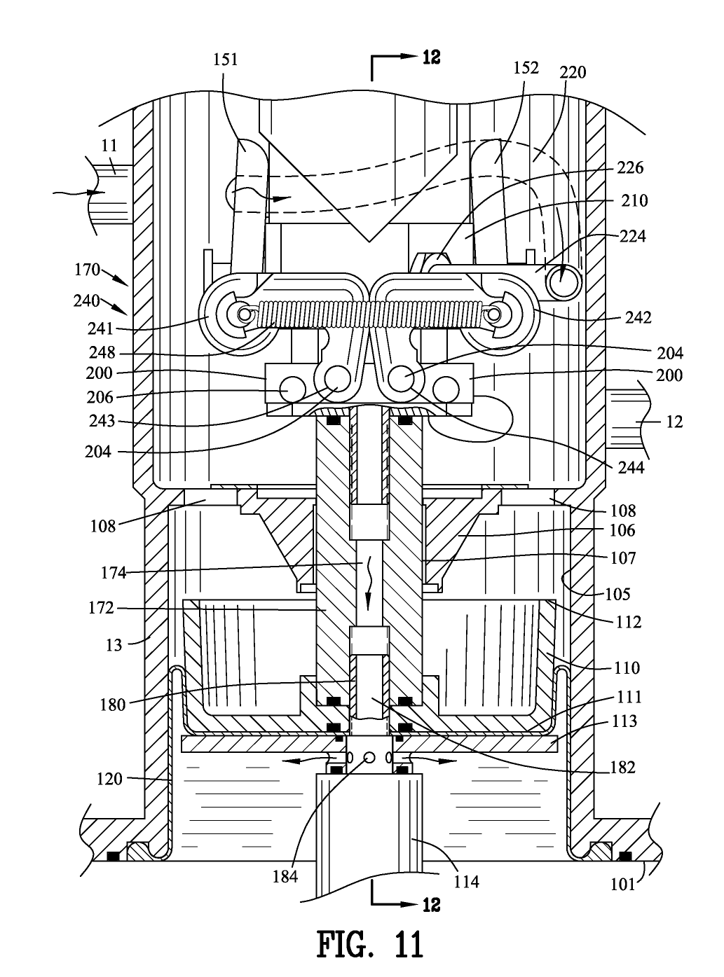

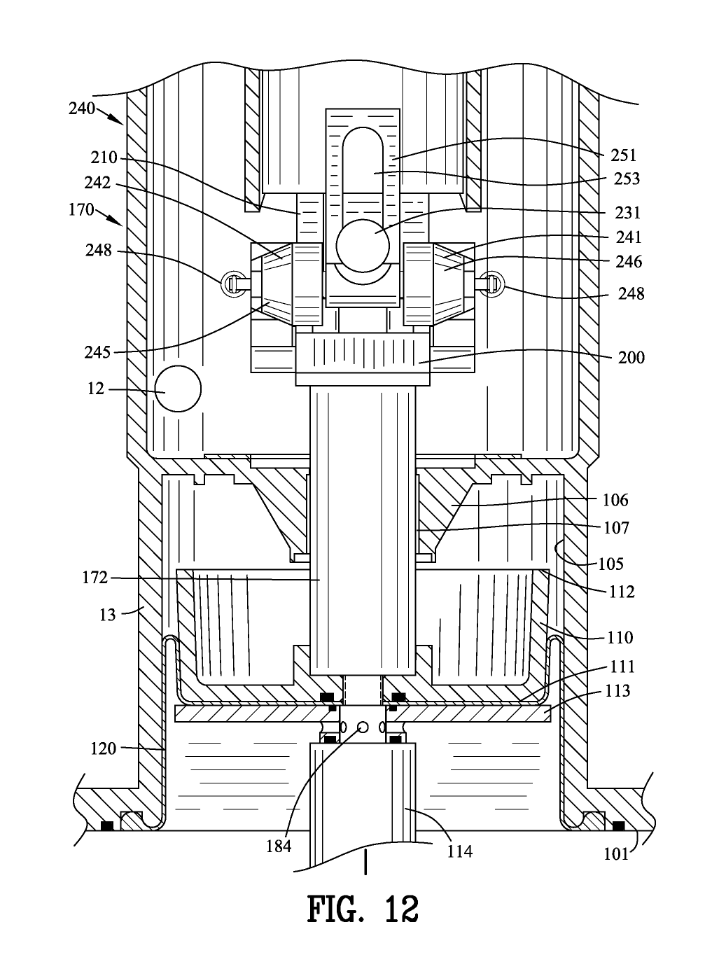

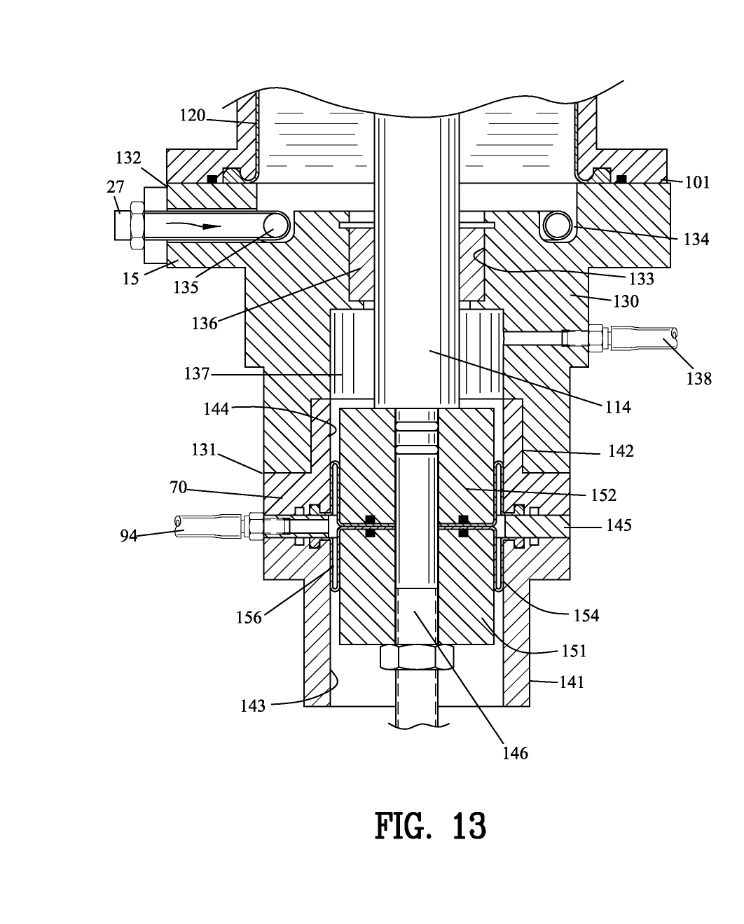

FIGS. 9-13 illustrate the mechanical engine driven water pump 5 of FIG. 4 in a second operating position. The hot vapor phase of the refrigerant fluid 25 enters the input port 11 and passes through flexible hose 224 to enter into the valve connecting shaft bore 174. The hot vapor phase of the refrigerant fluid 25 is directed by the location of the spring loaded toggle 240 to exit from the first port apertures 184. The hot vapor phase of the refrigerant fluid 25 expands from the first port aperture 184 into the engine bore 105 to apply fluid pressure to the first piston side 111 of the heat engine piston 110. The applied fluid pressure to the first piston side 111 of the heat engine piston 110 moves the heat engine piston 110 to the second operating position shown in FIGS. 9-13. The inner stuffing box lower and upper pistons 151 and 152 move in unison with the heat engine piston 110. Similarly, the condensate piston 274 moves with the heat engine piston 110.

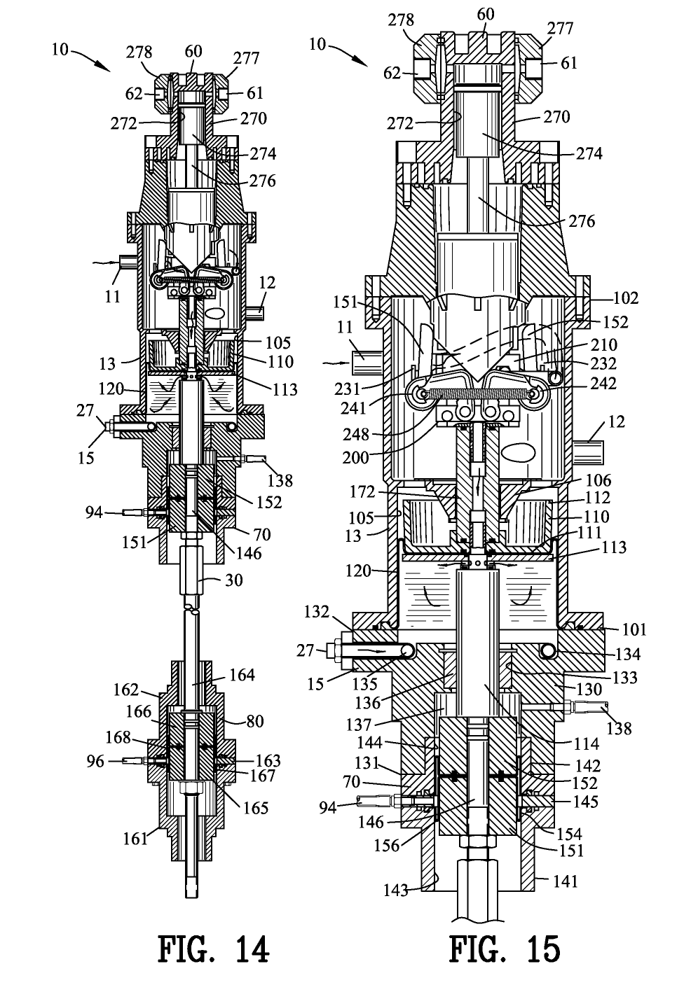

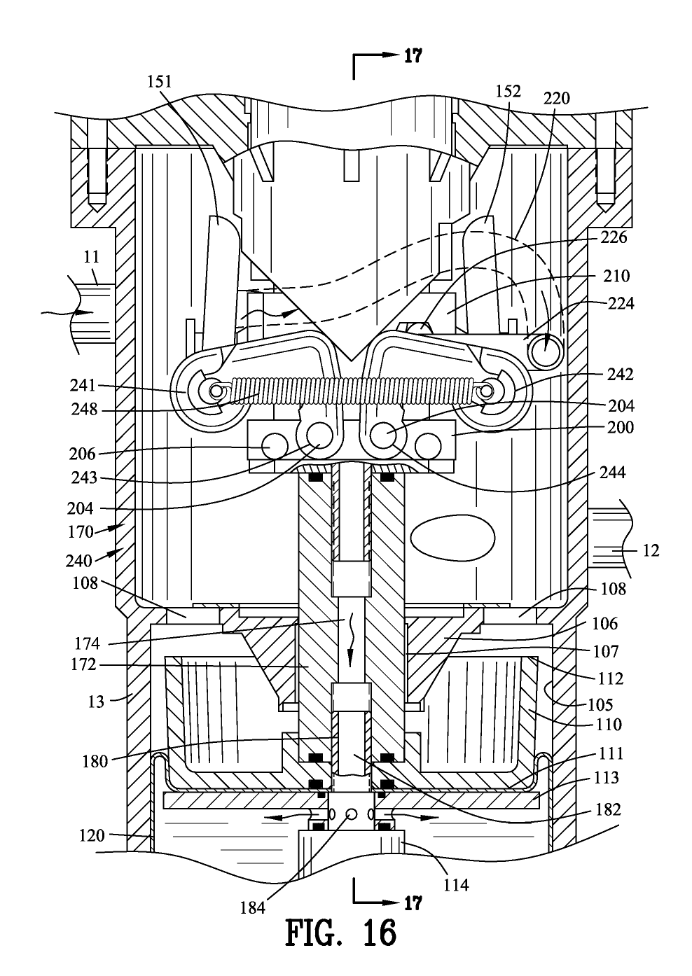

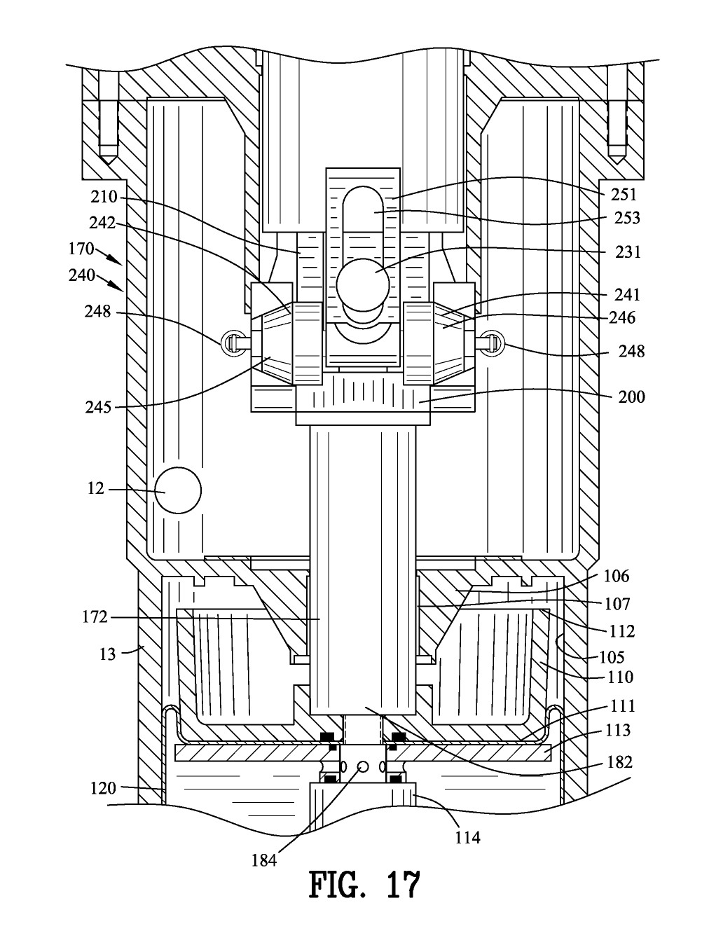

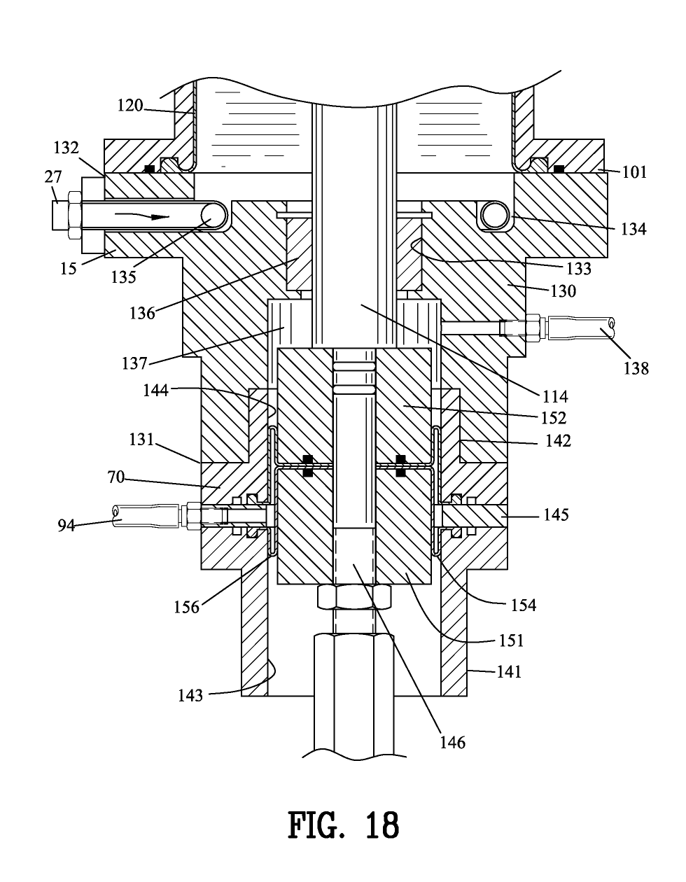

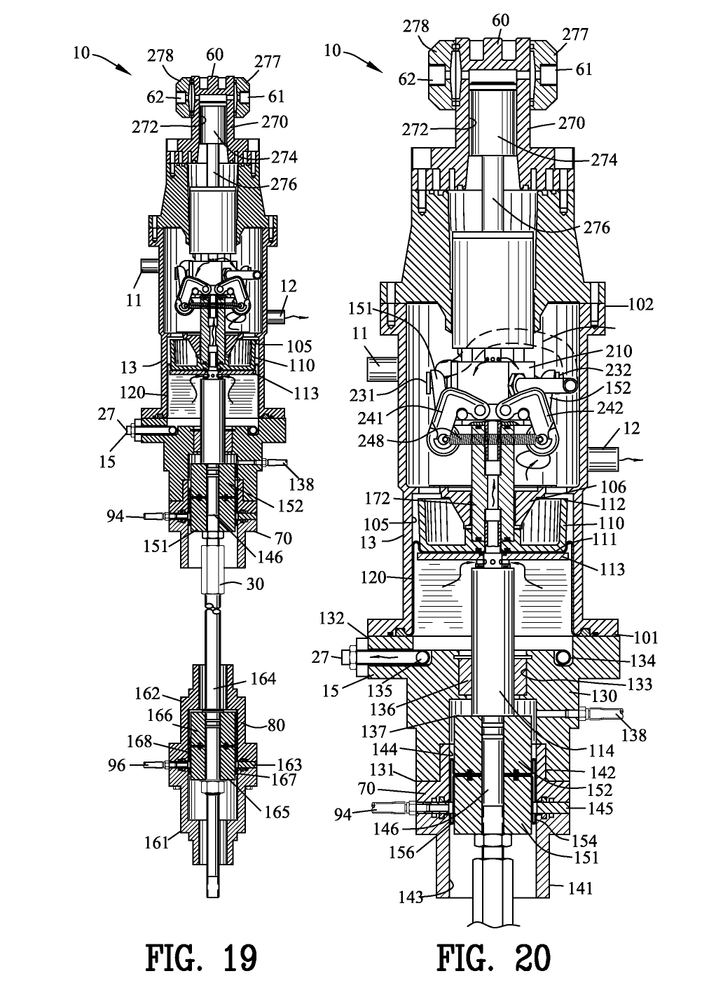

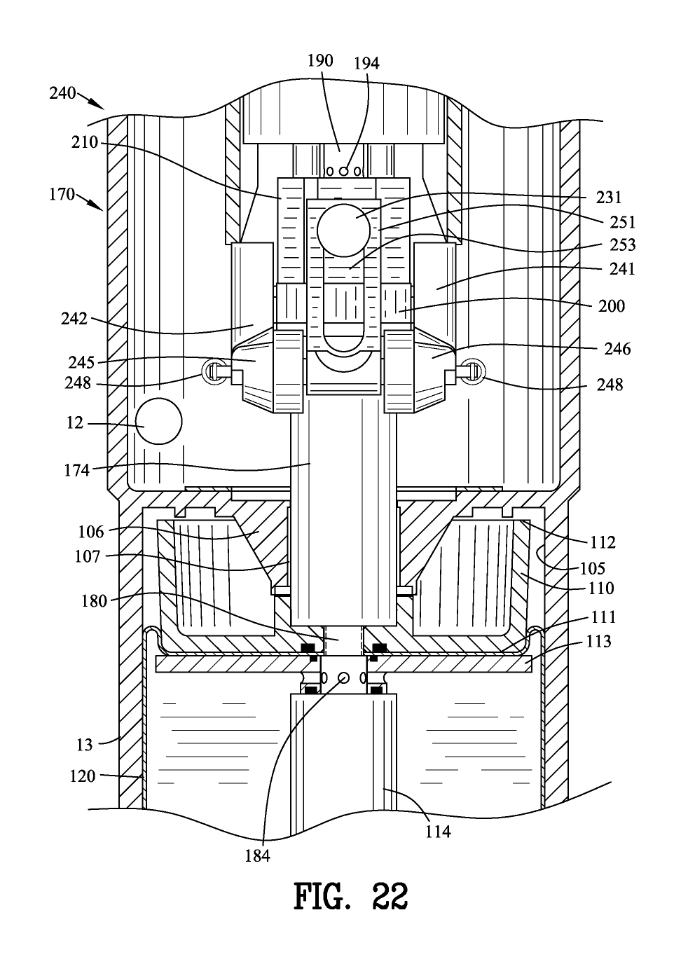

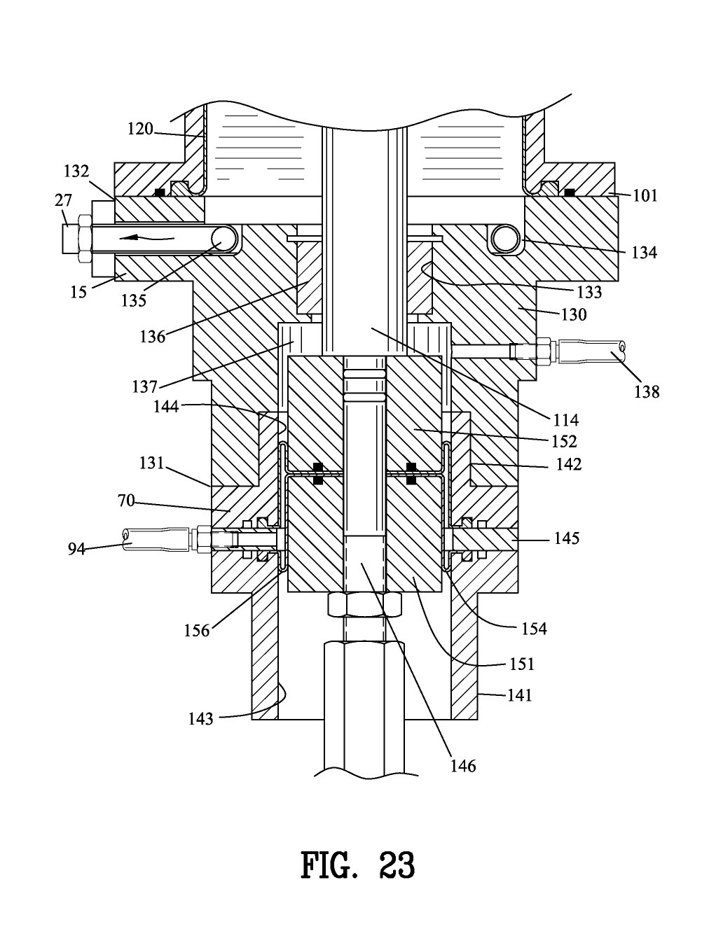

FIGS. 14-18 illustrate the mechanical engine driven water pump 5 of FIG. 4 in a third operating position. The continued flow of the hot vapor phase of the refrigerant fluid 25 into the input port 11 moves the heat engine piston 110 to the third operating position shown in FIGS. 14-18. The spring loaded toggle 240 is moved into engagement with the V-shaped stop 260. Continued upward movement of the heat engine piston 110 results in the V-shaped stop 260 toggling the spring loaded toggle 240 into a second location as shown in FIGS. 19-23.

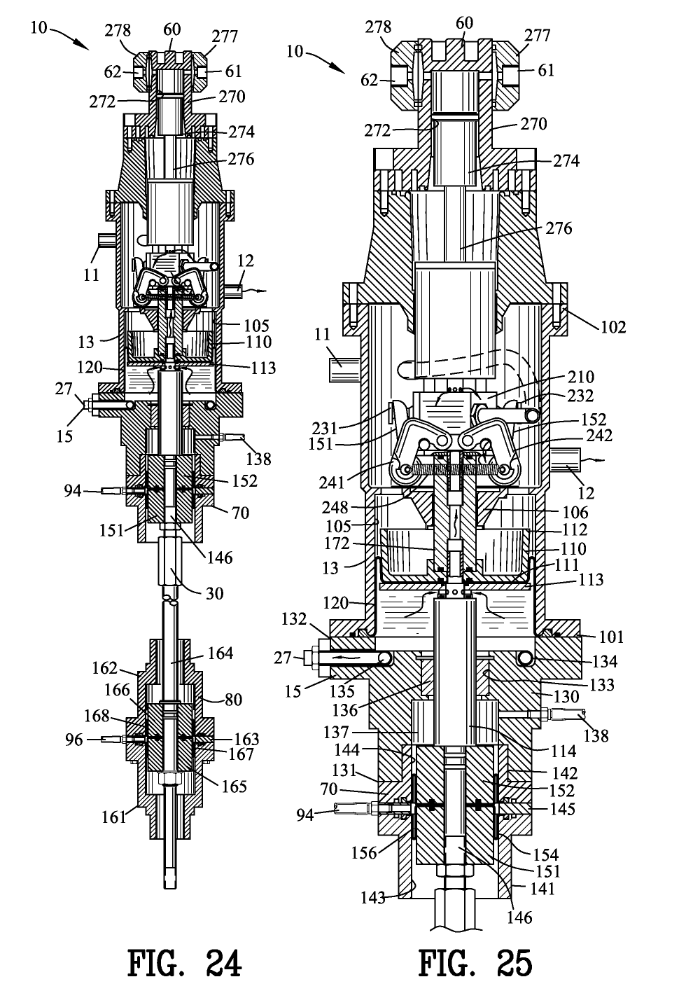

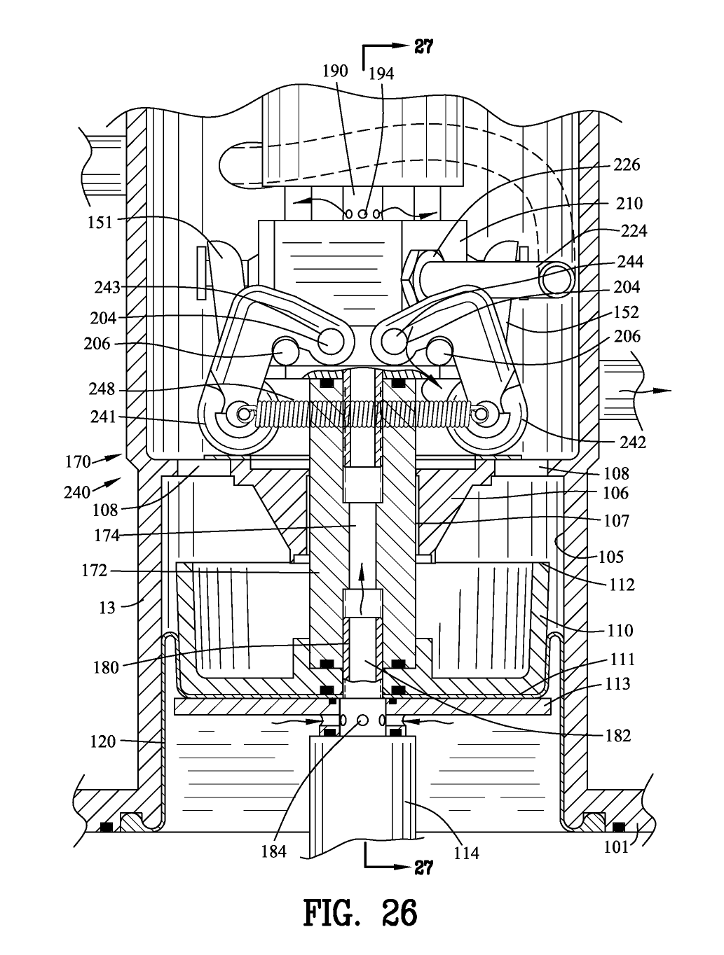

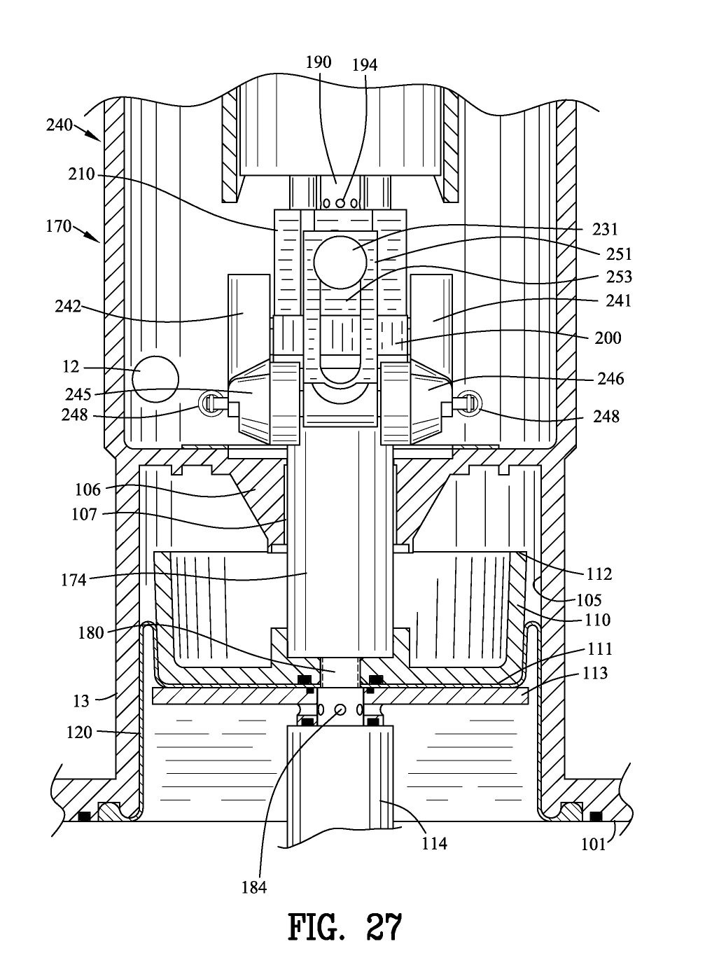

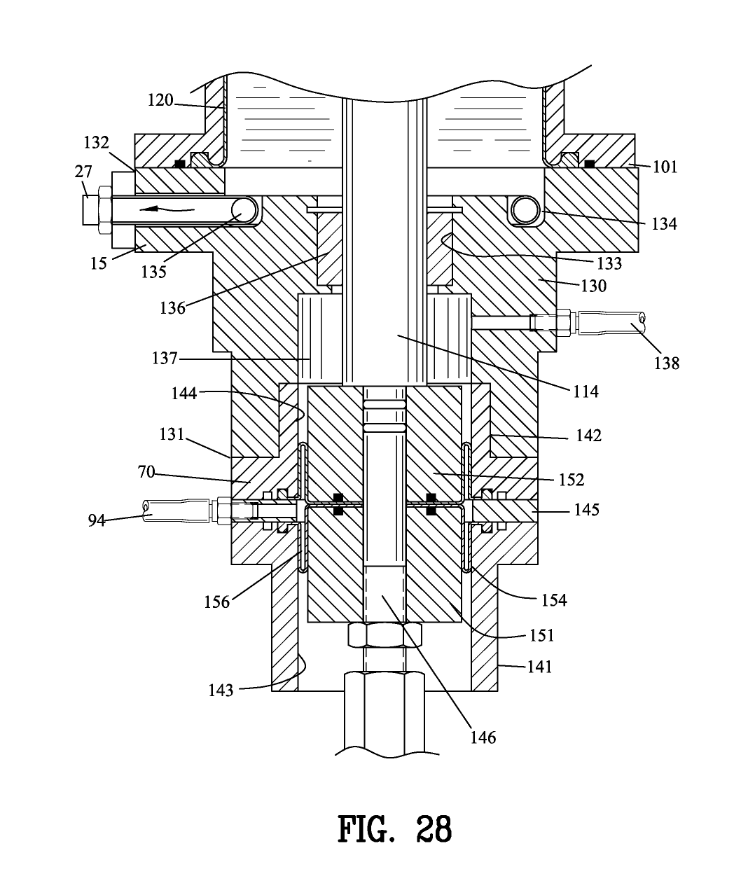

FIGS. 19-23 illustrate the mechanical engine driven water pump 5 of FIG. 4 in a forth operating position. The spring loaded toggle 240 is moved into the second location to close the port aperture 11 and to open the exhaust port aperture 194. The hot vapor phase of the refrigerant is fluid 25 is then exhausted from ports 184 out through ports 194 into engine bore 105 then exits through port 12. The weight of the rods are used to move the heat engine piston 110 downwardly to the position shown in FIGS. 24-28. The inner stuffing box lower and upper pistons 151 and 152 and the condensate piston 274 move in unison with the heat engine piston 110. Continued upward movement of the heat engine piston 110 results in the V-shaped stop 260 toggling the spring loaded toggle 240 into a second location as shown in FIGS. 19-23

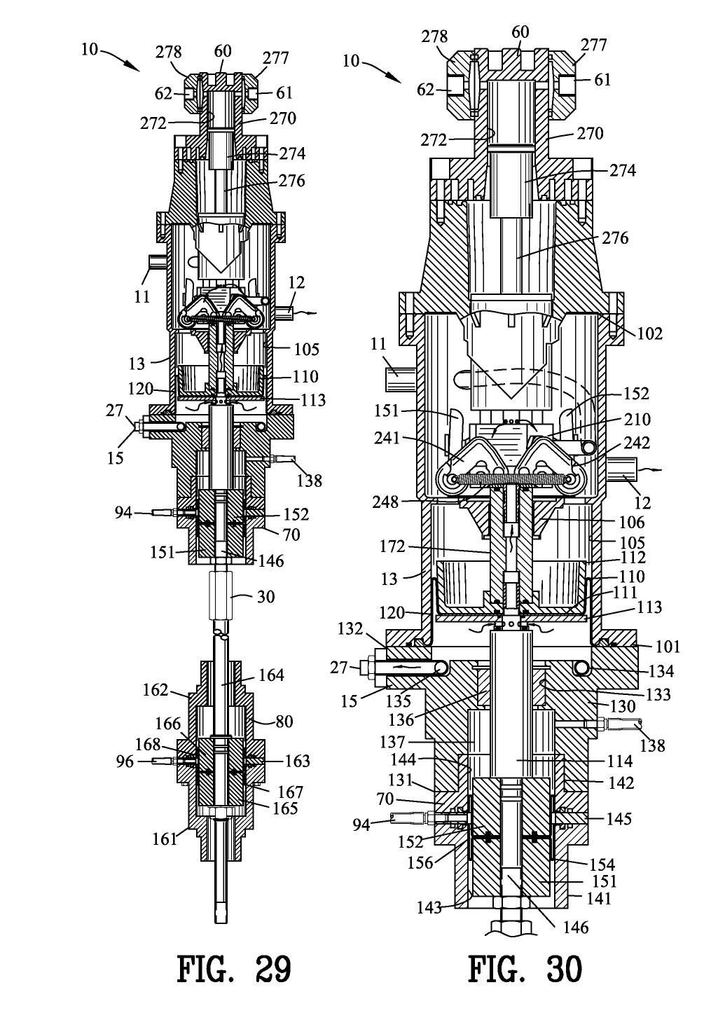

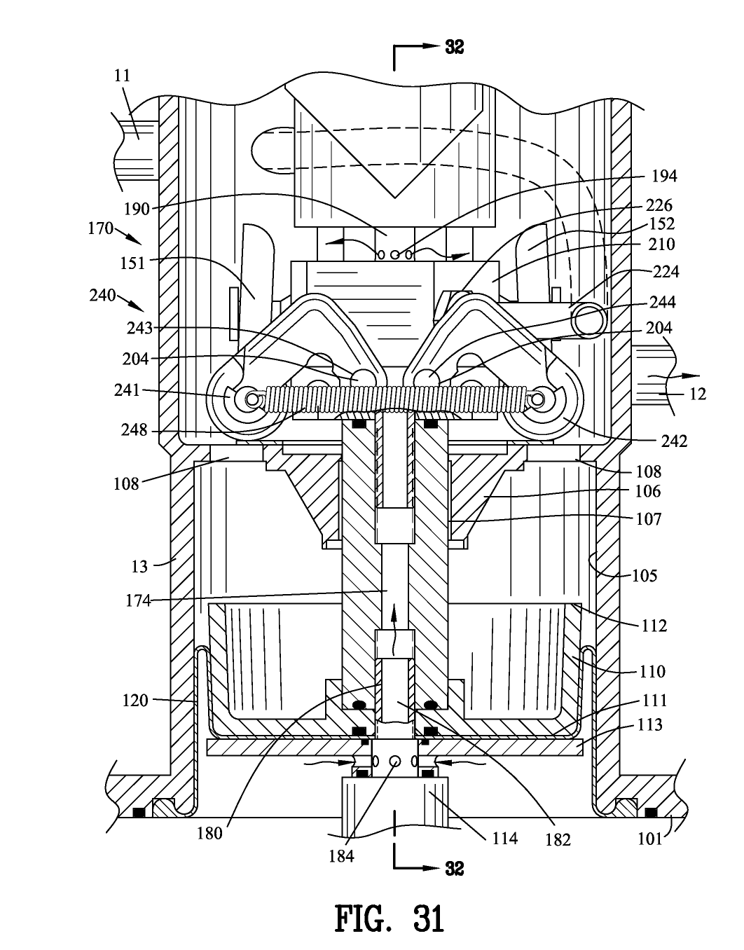

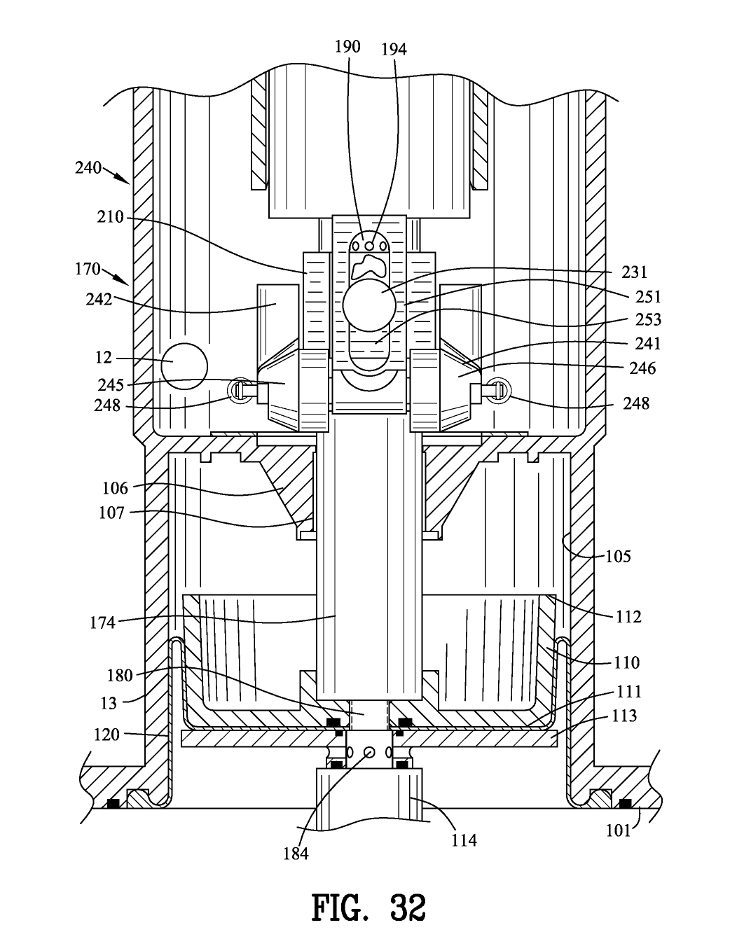

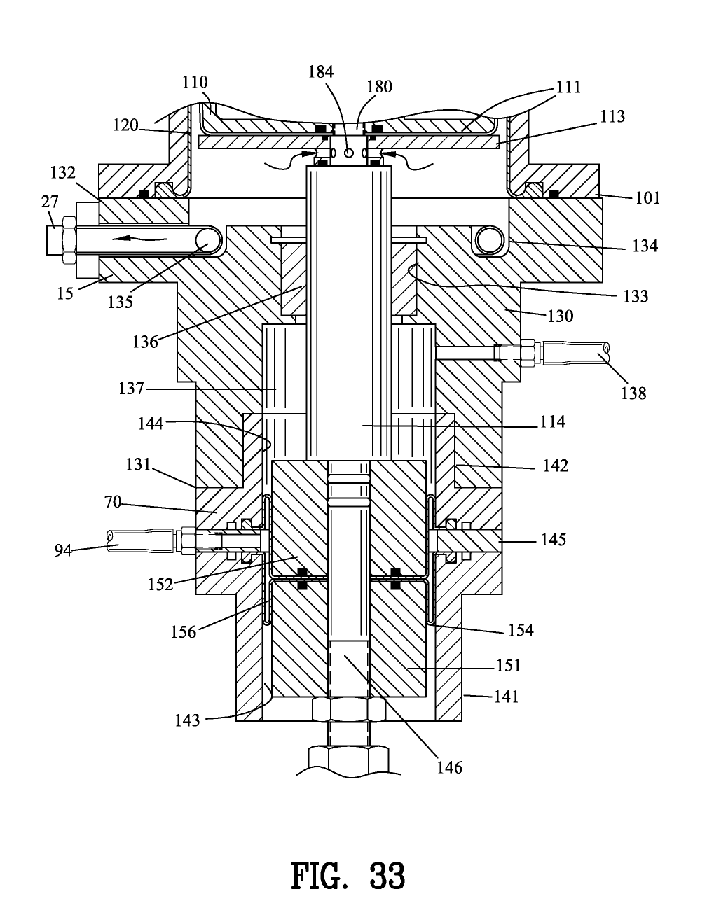

FIGS. 24-28 illustrate the mechanical engine driven water pump 5 of FIG. 4 in a fifth operating position. The continued weight of the rod continues to move the heat engine piston 110 to the sixth operating position shown in FIGS. 29-33. The cylindrical ends 245 and 246 of the spring loaded toggle 240 are moved into engagement with the housing support 106.

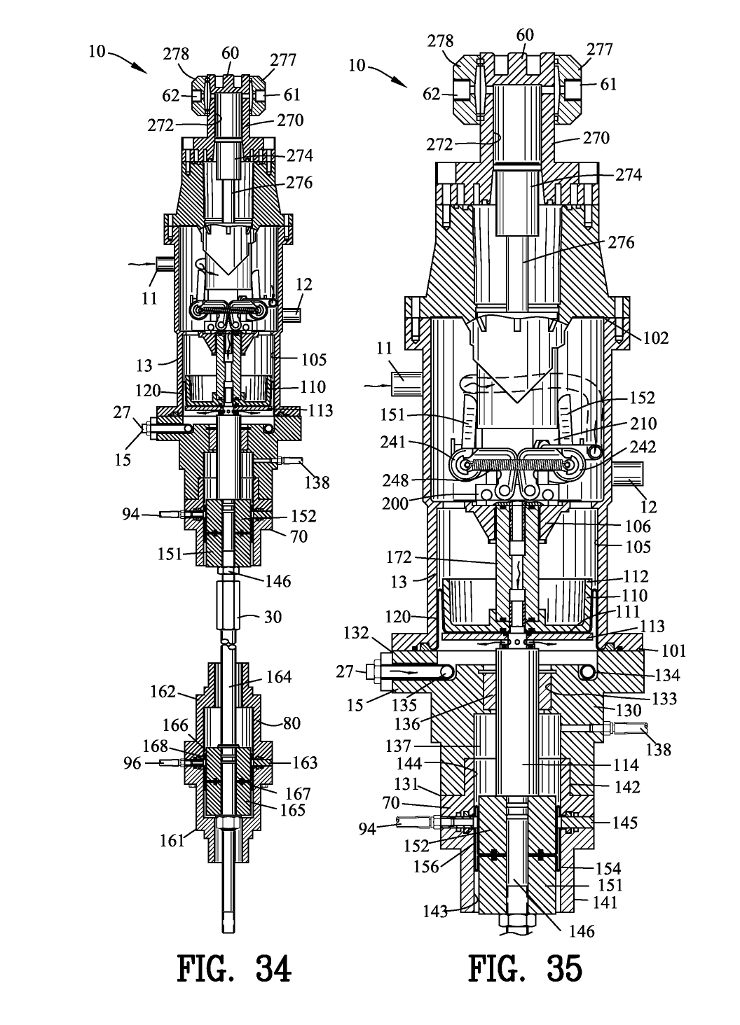

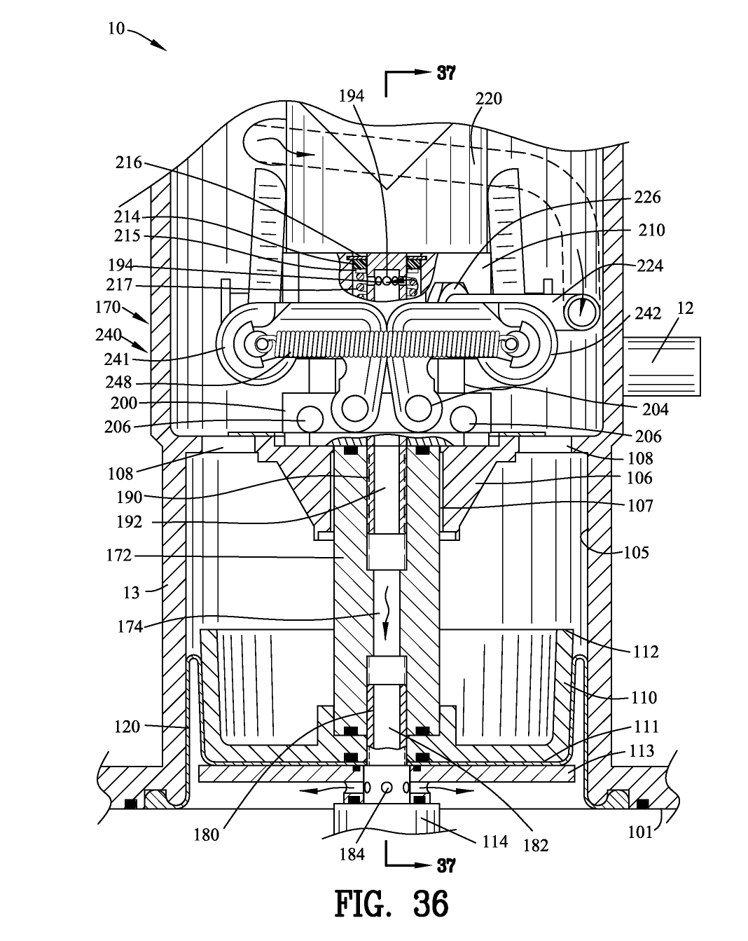

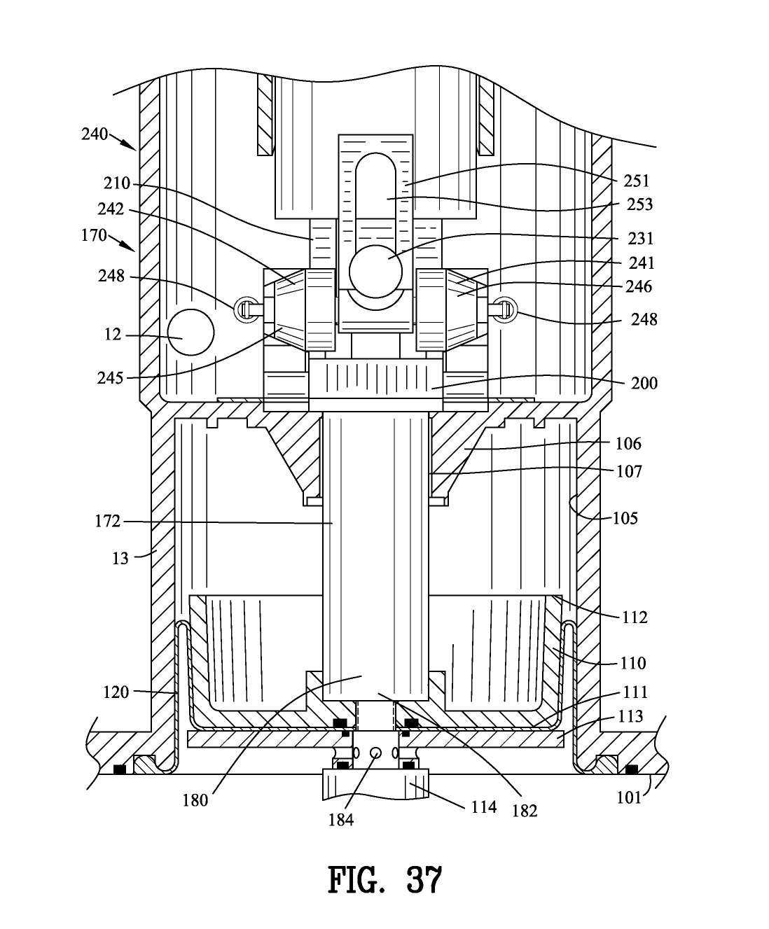

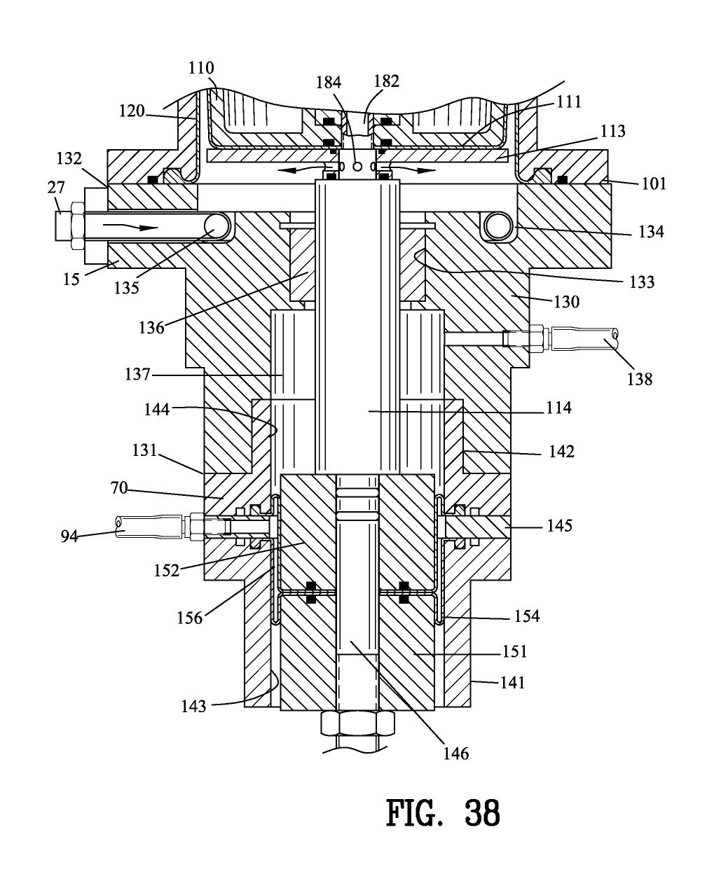

FIGS. 29-33 illustrate the mechanical engine driven water pump 5 of FIG. 4 in a sixth operating position. Continued downward movement of the heat engine piston 110 results in the housing support 106 moving the spring loaded toggle 240 back into a first location as shown in FIGS. 34-38.

FIGS. 34-38 illustrate the mechanical engine driven water pump 5 of FIG. 4 in a seventh operating position. The toggling of the spring loaded toggle 240 back into a first location power position and closing exhaust port apertures 194 and changes the direction of flow to port apertures 184. The operating cycle is repeated in the same manner.

The reciprocation of the condensate piston 274 provides recycling of the exhaust vapor phase of the refrigerant fluid 25 exiting from the output port 12. The inner stuffing box 70 provides plural diaphragms 154 and 156 for providing the positive seal for said mechanical reciprocating engine 10.

The present disclosure includes that contained in the appended claims as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A mechanical engine driven water pump for converting energy from an input heat source to a reciprocating mechanical output for powering the water pump, comprising:
an engine cylinder extending between a first and a second end;
an engine bore defined in said engine cylinder;
an input port and an output port extending through said engine cylinder;
an engine piston disposed in said engine bore;
an engine valve assembly slidably mounted to said engine piston for communicating said input port and said output port with opposed sides of the engine piston for effecting reciprocal motion of the engine piston;
a piston shaft connecting said reciprocal motion of the engine piston to provide the reciprocating mechanical output to the water pump; and
a stuffing box is interposed between said mechanical reciprocating engine and said reciprocating mechanical output for providing a positive seal for the mechanical reciprocating engine.

2. A mechanical engine driven water pump as set forth in claim 1, wherein the heat source comprises a differential in a fluid temperature.

3. A mechanical engine driven water pump as set forth in claim 1, wherein the heat source comprises a solar heat source.

4. A mechanical engine driven water pump as set forth in claim 1, wherein the heat source comprises a geothermal heat source

5. A mechanical engine driven water pump as set forth in claim 1, wherein the heat source comprises a byproduct heat source

6. A mechanical engine driven water pump as set forth in claim 1, wherein the heat source comprises an external burning of a petroleum product.

7. A mechanical engine driven water pump as set forth in claim 1, wherein the reciprocating mechanical output comprises a water pump.

8. A mechanical engine driven water pump as set forth in claim 1, wherein said engine valve assembly comprises a shuttle valve slidably mounted within said engine piston;
said shuttle valve having an internal tube bore communicating with opposed first and second sides of said engine piston; and
a spring loaded toggle for urging said shuttle valve into communicate between said input port and sequentially with said opposing first and second sides of said engine piston for effecting reciprocal motion of said engine piston.

9. A mechanical engine driven water pump as set forth in claim 1, wherein said engine valve assembly comprises a shuttle valve slidably mounted within said engine piston;
said shuttle valve having an internal tube bore communicating with opposed first and second sides of said engine piston;
a spring loaded toggle for urging said shuttle valve to communicate said input port with sequentially said opposing first and second sides of said engine piston for effecting reciprocal motion of the engine piston;
a spring loaded toggle for urging said shuttle valve into a first and a second toggle position; and
a mechanical actuator for actuating sequentially said spring loaded toggle into one of said first and a second positions to communicate said input port with sequentially said opposing first and second sides of said engine piston for effecting reciprocal motion of the engine piston.

10. A mechanical engine driven water pump as set forth in claim 1, including a stuffing box connected to said engine cylinder for sealing said piston shaft.

11. A mechanical engine driven water pump as set forth in claim 1, including a stuffing box connected to said engine cylinder for sealing said piston shaft; and
said stuffing box including plural diaphragms for providing the positive seal for said mechanical reciprocating engine.
